(19) United States
(12) Patent Application Publication
(10) Pub. No.: US 2024/0144482 A1
(43) Pub. Date: May 2, 2024

(54) METHODS, DEVICES, AND SYSTEMS FOR SPATIAL TRANSCRIPTOME SLIDE ALIGNMENT

(71) Applicant: Regeneron Pharmaceuticals, Inc., Tarrytown, NY (US)

(72) Inventors: Peter Lais, Tarrytown, NY (US); Shawn Mishra, Tarrytown, NY (US); Yu Bai, Tarrytown, NY (US); Gurinder S. Atwal, Tarrytown, NY (US)

(21) Appl. No.: 18/499,538

(22) Filed: Nov. 1, 2023

Related U.S. Application Data
(60) Provisional application No. 63/381,813, filed on Nov. 1, 2022.

(51) Int. Cl. G06T 7/00

(52) U.S. Cl. CPC G06T 7/0014; G06T 2207/20081; G06T 2207/20084; G06T 2207/30024

(57) ABSTRACT

Technologies are provided for alignment of spatial transcriptome slides of biological tissue. The alignment of images and the coordinates of spots within transcriptome profiles of the biological tissue can utilize an alignment model that can be machine-learned and can receive both a displaced image to be aligned and a reference image as inputs. The alignment model may learn a diffeomorphic transformation between those images. Such a transformation can be readily applied to the alignment of the displaced image and to the alignment of the displaced coordinates of spots within the transcriptome profiles of transcriptome. In some cases, transcriptome data can be analyzed and cast in an image-like format, and can then be utilized as supplementary input to the alignment model. The alignment model can be trained in a tissue agnostic manner, such as by using synthetic images.

### CROSS-REFERENCE TO RELATED APPLICATION

This application claims priority to U.S. Provisional Application No. 63/381,813, filed on Nov. 1, 2022, the entirety of which is incorporated by reference herein.

### SUMMARY

It is to be understood that both the following general description and the following detailed description are illustrative and explanatory only and are not restrictive. In one embodiment, the disclosure provides a computer-implemented method. The computer-implemented method includes receiving a reference image of biological tissue and receiving a displaced image of the biological tissue. The computer-implemented method also includes applying a normalization process to the reference image, resulting in a normalized reference image, and applying the normalization process to the displaced image, resulting in a normalized displaced image. The computer-implemented method further includes performing a first registration of the normalized displaced image relative to the normalized reference image. Performing such a first registration results in a group of parameters defining a coarse transformation and further results in a second displaced image. The computer-implemented method still further includes supplying the normalized reference image to a machine-learning alignment model, supplying the second displaced image to the machine-learning alignment model, and performing a second registration of the second displaced image relative to the reference image by applying the machine-learning alignment model to the reference image and the second displaced image. Applying the machine-learning alignment model yields a deformation vector field representative of a registration transformation between the reference image and the second displaced image.

In addition, the computer-implemented method also can further include receiving reference spatial coordinates of spots within a first transcriptome profile of the biological tissue. The first transcriptome profile corresponds to the reference image. Each one of the spots includes one or more cells. The computer-implemented method also can include receiving displaced spatial coordinates of spots within a second transcriptome profile of the biological tissue, the second transcriptome profile corresponding to the displacement image. The computer-implemented method also can include performing, based on the coarse transformation, a first registration of the displaced spatial coordinates relative to the reference spatial coordinates, resulting in second displaced spatial coordinates of the spots within the second transcriptome profile; and performing, based on the registration transformation, a second registration of the second displaced spatial coordinates of the spots within the second transcriptome profile.

In yet another embodiment, the disclosure provides another computer-implemented method. That other computer-implemented method includes generating, based on multiple pairs of training label maps, multiple pairs of training images, wherein each pair of the multiple pairs of training images comprises a training reference image and a training displaced image. That other computer-implemented method also includes determining a solution to an optimization problem with respect to a loss function based on a similarity metric of a pair of training label maps and a deformation vector field representative of a registration transformation between a first training reference image and a first training displaced image in a pair of the multiple pairs of training images. The solution defines an alignment model for registration of an evaluation displaced image of biological tissue relative to an evaluation reference image of the biological tissue.

Additional elements or advantages of this disclosure will be set forth in part in the description which follows, and in part will be apparent from the description, or may be learned by practice of the subject disclosure. The advantages of the subject disclosure can be attained by means of the elements and combinations particularly pointed out in the appended claims.

This summary is not intended to identify critical or essential features of the disclosure, but merely to summarize certain features and variations thereof. Other details and features will be described in the sections that follow. Further, both the foregoing general description and the following detailed description are illustrative and explanatory only and are not restrictive of the embodiments of this disclosure.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure can be implemented in many different forms and should not be construed as limited to the implementations set forth herein. Like numbers refer to like elements throughout. The patent or application file contains at least one drawing executed in color. Copies of this patent or patent application publication with color drawing(s) will be provided by the Office upon request and payment of the necessary fee.

FIG. 1 illustrates an example of a computing system, in accordance with one or more embodiments of this disclosure.

FIG. 1A illustrates an example workflow, in accordance with embodiments of this disclosure.

FIG. 1B illustrates examples of a reference image and displaced image of biological tissue and respective normalized images, in accordance with embodiments of this disclosure.

FIG. 1C illustrates examples of a set of reference spot coordinates in a reference slide and a set of displaced spot coordinates in a displaced slide, in accordance with aspects described herein.

FIG. 2 illustrates an example of an alignment model, in accordance with one or more embodiments of this disclosure.

FIG. 3 illustrates another example of a computing system, in accordance with one or more embodiments of this disclosure.

FIG. 4A illustrates examples of input images of biological tissue, one of the exemplified images is a reference image and the other one is an affine-transformed displaced image.

FIG. 4B illustrates example of tile images, in accordance with one or more embodiments of this disclosure.

FIG. 5A illustrates an example of four tile deformation vector fields, in accordance with one or more embodiments of the disclosure.

FIG. 5B illustrates an example of deformation vector field resulting from multiple tile deformation vector fields, in accordance with one or more embodiments of the disclosure.

FIG. 6 illustrates an example computing system to train, using synthetic training data, an alignment model, in accordance with one or more embodiments of this disclosure.

FIG. 6A schematically depicts an example process flow to generate the reference label map and the displaced label map and to generate a synthetic training reference image and a synthetic training displaced image in accordance with aspects described herein.

FIG. 7A illustrates examples of alignment performance for small slides using simulated deformations, in accordance with embodiments of this disclosure.

FIG. 7B illustrates examples of alignment performance for small slides using simulated deformations, in accordance with embodiments of this disclosure.

FIGS. 8A and 8B illustrate examples of alignment performance for full spatial slides of mouse brain with simulated deformations, in accordance with embodiments of this disclosure.

FIGS. 8A and 8B illustrate examples of alignment performance for full spatial slides of mouse brain with simulated deformations, in accordance with embodiments of this disclosure.

FIG. 9 illustrates an example of alignment performance for full spatial slides of human lymph node using simulated deformations, in accordance with embodiments of this disclosure.

FIG. 10 illustrates an example of alignment performance for more than two slides using simulated deformations, in accordance with embodiments of this disclosure.

FIG. 11 illustrates an application of an alignment model in accordance with embodiments of this disclosure to the alignment of two slides of mouse brain with real deformations.

FIG. 12 illustrates an example of a computer-implemented method for aligning images and spatial coordinates of spots within the transcriptome profile of biological tissue to a common coordinate system, in accordance with one or more embodiments of this disclosure.

FIG. 13 illustrates an example of a computer-implemented method for normalizing images of biological tissue, in accordance with one or more embodiments of this disclosure.

FIG. 14 illustrates an example of computer-implemented method for normalizing images of biological tissue using transcriptome profiling data, in accordance with one or more embodiment of this disclosure.

FIG. 15 illustrates an example of a computer-implemented method for training a machine-learning (ML) alignment model, in accordance with one or more embodiments of this disclosure.

FIG. 16 illustrates an example of a computer-implemented method for generating synthetic training data for training an ML alignment model, in accordance with one or more embodiments of this disclosure.

FIG. 17 illustrates an example of a computer-implemented method for obtaining an alignment model and aligning images of biological tissue to a reference coordinate system, in accordance with one or more embodiments of this disclosure.

FIG. 18A illustrates results of alignment performance in accordance with embodiments of this disclosure.

FIG. 18B illustrate results of alignment performance in accordance with embodiments of this disclosure.

FIG. 18C illustrates results of alignment performance in accordance with embodiments of this disclosure.

FIG. 18D illustrates results of alignment performance in accordance with embodiments of this disclosure.

FIG. 18E illustrates results of alignment performance in accordance with embodiments of this disclosure.

FIG. 18F illustrates results of alignment performance in accordance with embodiments of this disclosure.

FIG. 18G illustrates results of alignment performance in accordance with embodiments of this disclosure.

FIG. 18H illustrates results of alignment performance in accordance with embodiments of this disclosure.

FIG. 18I illustrates results of alignment performance in accordance with embodiments of this disclosure.

FIG. 18J illustrates results of alignment performance in accordance with embodiments of this disclosure.

FIG. 19 illustrates an example of computing system to implement slide alignment, in accordance with one or more embodiments of the disclosure.

### DETAILED DESCRIPTION

The disclosure recognizes and addresses, among other technical challenges, the issue of alignment of images and spatial coordinates of spots within the transcriptome profiles of slides of biological tissue relative to one another, with respect to a common coordinate system. Biological tissue can include sections of a human organ or an organ of another type of animal, for example. Embodiments of the disclosure include computer-implemented methods, computing devices, computing systems, and computer program products that, individually or in combination, permit aligning an image and a set of spatial coordinates of spots within the transcriptome profiles of a slide of biological tissue and another image and another set of spatial coordinates of spots within the transcriptome profiles of another slide of the biological tissue relative to one another, with respect to a common coordinate system. More specifically, embodiments of the disclosure, individually or in combination, utilize an alignment model that can be machine-learned. The alignment model can include, for example, a convolutional neural network, and can receive both a displaced image to be aligned and a reference image as inputs, and learns a diffeomorphic transformation between those images. Such a transformation, referred for simplicity as registration transformation, can be readily applied to the alignment of the displaced image and the alignment of the displaced spatial coordinates of spots within the transcriptome profiles. In addition, transcriptome data can be analyzed and cast in an image-like format, and can then be utilized as supplementary input for the alignment model. The alignment model can be trained in a tissue agnostic manner, using synthetic images. Therefore, the alignment model can be broadly applicable.

Embodiments of the disclosure can provide various improvements and efficiencies compared to existing technologies for automated alignment of displaced spatial coordinates of spots within transcriptome profiles of slides of biological tissue. For example, embodiments of the disclosure can utilize graphics processing units (GPUs) instead of or in addition to central processing units (CPUs). As a result, processing speed can be superior to that of existing technologies. In addition, or as another example, because optical imaging can be combined with spatial transcriptome profiling in order to align images and the spatial coordinates of spots, the reliability of the alignment can be superior to that of existing technologies. Further, as a yet another example, by training and applying a machine-learning model to use as alignment model, the alignment of images and the spatial coordinates of spots avoids the use or landmarks or other types of fiduciary markers, and also manual alignment. Furthermore, or as still another example, the training of the machine-learning model can be based on synthetic images and is tissue-agnostic, resulting is far greater flexibility and applicability of the image and spot alignment described in this disclosure. Additionally, by relying on a tiling-and-stitching approach, images having sizes that are larger than the image size used in the training of the machine-learning model can be readily analyzed.

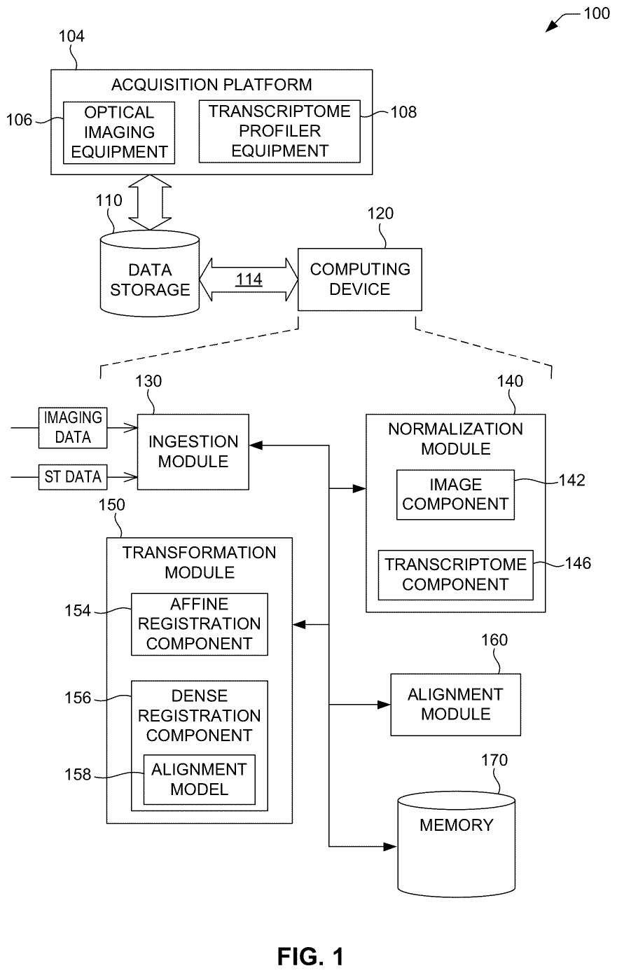

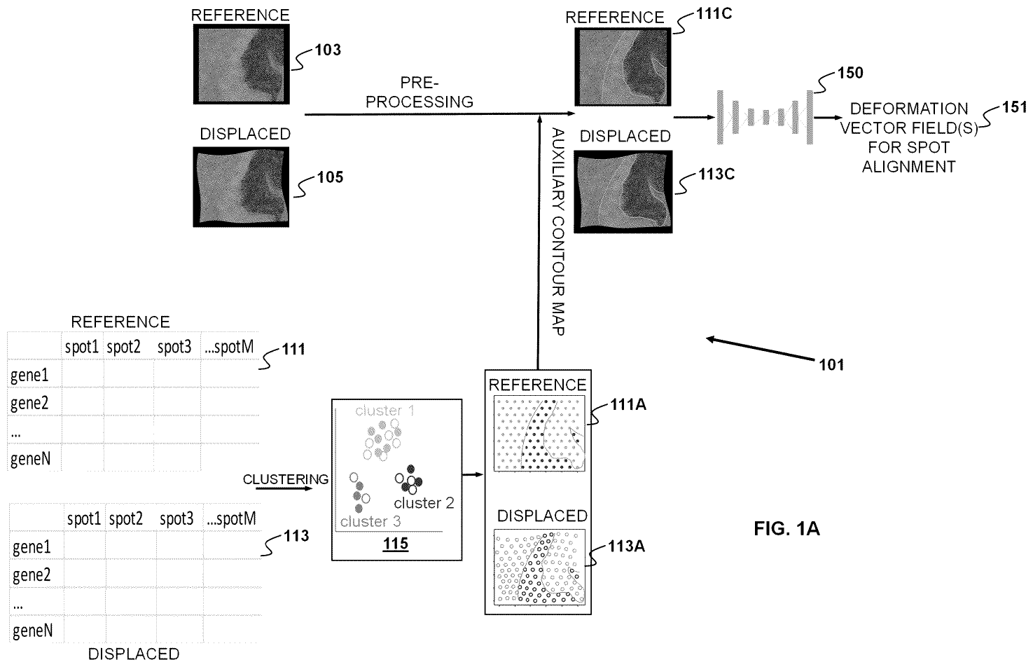

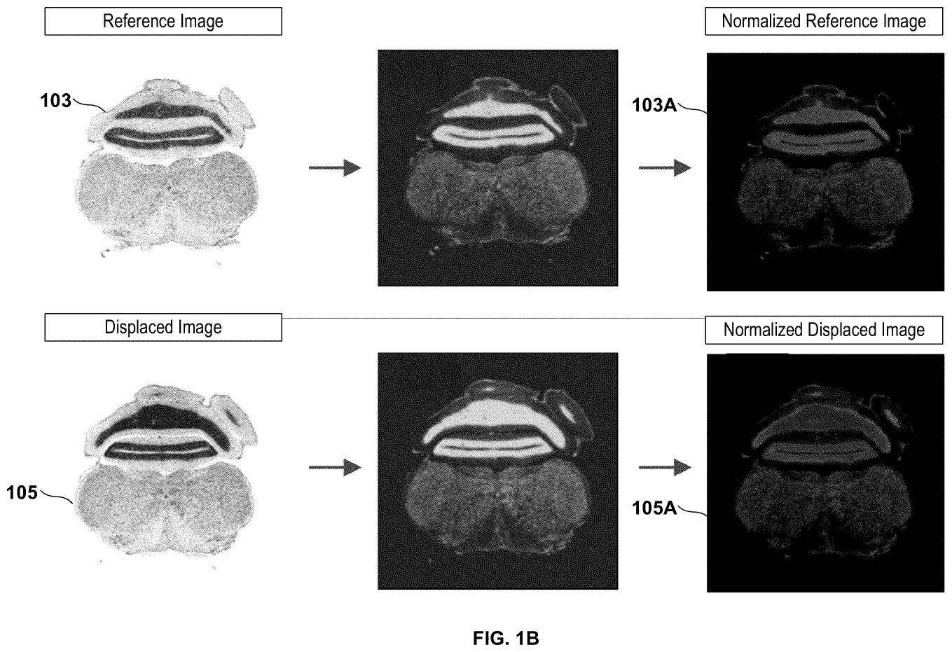

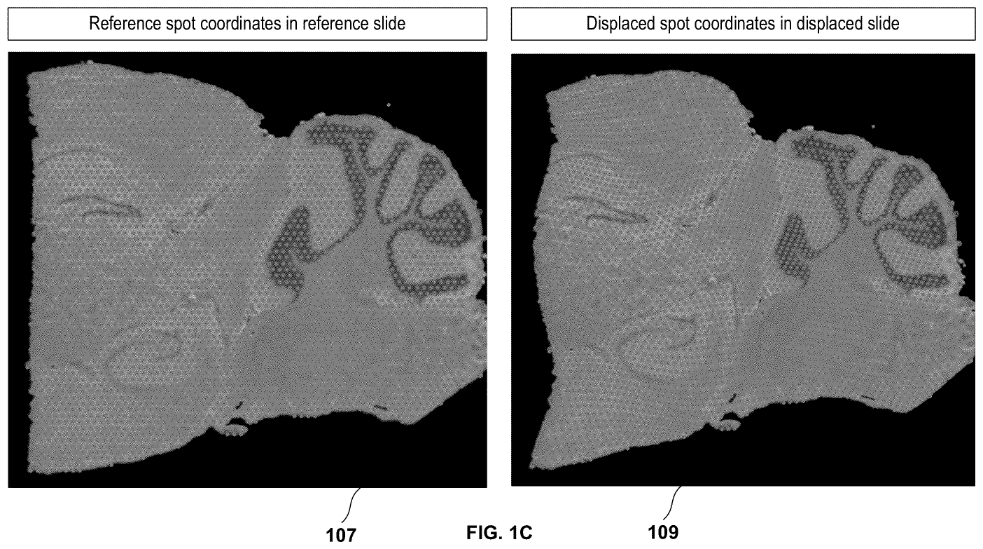

FIG. 1 illustrates an example computing system 100, in accordance with one or more embodiments of this disclosure. The computing system 100 includes a data acquisition platform 104 that can permit measuring and collecting data of various types. Specifically, the data acquisition platform 104 can include optical imaging equipment 106 and transcriptome profiler equipment 108. The optical imaging equipment 106 can permit generating, using light (visible or otherwise) images of slides of biological tissue. The transcriptome profiler equipment 108 can permit generating spatial transcriptome profiling data of slides of biological tissue. The transcriptome profiler equipment 108 can generate such data with one or various spatial resolutions including near single-cell resolution, single-cell resolution and/or sub-cell resolution. The computing system 100 also includes one or multiple memory devices 110 (referred to as data storage 110) that can retain imaging data indicative of images of slides of biological tissue. The imaging data can be retained in one or multiple files within a filesystem configured in the data storage 110. Each of the one or multiple files can be formatted according to suitable format for image storage. In some cases, the images can be histological staining images. Such images can be obtained using H&E (hematoxylin and eosin solution) staining. Embodiments of this disclosure are not limited in this respect, and can be applied to images obtained using other types of histology staining techniques. In other cases, the images can be immunohistochemistry staining (IHC) images. In yet other cases, the images can be in situ hybridization (ISH) images, including fluorescent in situ hybridization (FISH) images. In still other cases, the images can be single-molecule fluorescence in situ hybridization (smFISH) images. Accordingly, data generated by the data acquisition platform 104 and retained in the data storage 110 can include various types of data, in some embodiments, single-cell data can include single cell RNA-seq data (scRNA-seq) or single nucleus RNA-seq data (snRNA-seq). In some embodiments, the single-cell data can include single cell ChIP. In some embodiments, the single-cell data can include single cell ATAC-seq. In some embodiments, the single-cell data can include single cell proteomics. In some embodiments, the spatial data can be coarse grained. In some embodiments, the spatial data also can include STARmap and/or MERFISH. In some embodiments, the single cell data is multi-modal single cell data. In some embodiments, the multi-modal data is single cell RNA-seq and chromatin accessibility data (SHARE-seq). In some embodiments, the multi-modal data is single cell RNA-seq and proteomics data (CITE-seq). In some embodiments, the multi-modal data is single cell RNA-seq and paten-clamping electrophysiological recording and morphological analysis of single neurons (Patch-seq).

The data storage 110 also can retain transcriptome profiling data including multiple datasets corresponding to respective images of the slides of biological tissue. Each one of the multiple datasets containing transcriptome profiling data for a respective slide of the slides of biological tissue can be acquired simultaneously with the optical imaging of that respective slide. That is, a first dataset containing transcriptome profiling data for a first slide of biological tissue can be acquired simultaneously with the optical imaging of that first slide; a second dataset containing transcriptome profiling data for a second slide of the biological tissue can be acquired simultaneously with the optical imaging of the second slide; and so forth.

The computing system 100 also includes a computing device 120 that is functionally coupled to the data storage 110 via a communication architecture 114 (e.g., wireless network(s), wireline networks, wireless links, wireline links, server devices, router devices, gateway devices, a combination thereof, or the like). The computing device 120 can include computing resources (not depicted, for the sake of clarity) comprising, for example, one or more central processing units (CPUs), one or more graphics processing units (GPUs), one or more tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources.

The computing device 120 can include an ingestion module 130 that can access, from the data storage 110, images of slides of biological tissue and transcriptome profiling data. Accessing the imaging data can include, from example, downloading the images and/or the transcriptome profiling data programmatically from the data storage 110. For example, the ingestion module 130 can download the images and/or the transcriptome profiling data via an application programming interface (API). By executing one or more function calls of the API, the ingestion module 130 can receive image files (or the data constituting the files) corresponding to the images, and can retain the image files (or the data constituting the files) within one or more non-volatile memory devices 170 (referred to as memory 170). As another example, the ingestion module 130 can download the images and/or the transcriptome profiling data by executing a script to copy the image files from the filesystem within the data storage 110 to the memory 170. The memory 170 can be integrated into the computing device 250.

Turning now to the workflow 101 shown in FIG. 1A, the ingestion module 130 can receive an image of a slide of the biological tissue. The image can be referred to a reference image 103 (or fixed image) and can serve to establish a reference two-dimensional (2D) coordinate system. A position of a pixel within the reference image 103 can be defined with respect to that 2D coordinate system. The reference image 103 also can be referred to as a “fixed image.” In addition, the ingestion module 130 also can receive an image of another slide of the biological tissue. Such an image can be referred to as displaced image 105 because multiple slides of a section of biological tissue can be displaced relative to one another. A position of a pixel within the displaced image 105 need not be defined within the reference 2D coordinate system. Thus, a pixel at a particular position within the displaced image 105 need not correspond to a pixel at that same position in the reference image 103. The displaced image 105 also can be referred to as “moving image.” Further examples of a reference image 103 and a displaced image 105 are shown in FIG. 1B.

The computing device 120 can align the displaced image 105 and the displaced spatial coordinates of spots where transcriptome is profiled on the displaced slide relative to the 2D reference coordinate system. Prior to that alignment, the computing device 120 can operate on the reference image 103 and the displaced image 105 by applying a normalization process. The normalization process is applied to generate a normalized image representing a tissue mask image. To that end, the computing device 120 can include a normalization module 140 that can apply the normalization process.

As part of the normalization process, the normalization module 140 can determine if color normalization is to be applied. Color normalization can be applied in situations where noticeable color deviation from an expected color palette and/or color inconsistency across the reference image 103 and the displaced image 105 is detected. To make such a determination, the normalization module 140 can apply a color deviation criterion and/or a color inconsistency criterion to both the reference image 103 and the displaced image 105. In some cases, neither the color deviation criterion nor the color inconsistency is satisfied, and, thus, the normalization module 140 can determine that color normalization is not to be applied. In other cases, in response to at least one of such criteria being satisfied, the normalization module 140 can determine that color normalization is to be applied to both the reference image 103 and the displaced image 105. Hence, an image component 142 included in the normalization module 140 can receive the reference image 103 and can apply color normalization to the reference image 103. The reference image 103 can be received from the memory 170, for example. In addition, the image component 142 can receive the displaced image 105 and can apply color normalization to the displaced image 105. The displaced image 105 can be received from the memory 170. Applying color normalization can include scaling each RGB color channel such that at each pixel of an input image (the reference image or the displaced image), the intensity value in each channel is in the interval [0,1].

Regardless of whether color normalization is applied, the image component 142 can further apply the normalization process to the reference image 103 and the displaced image 105. As a result, the image component 142 generates a normalized reference image and a normalized displaced image. To apply the normalization process, the image component 142 can receive an input image (e.g., the reference image 101 or the displaced image 103). The input image can be received from the memory 170. The image component 142 can then generate a tissue mask image for the input image by separating tissue foreground pixels and the non-tissue background pixels. In situations where the input image is a histology image of biological tissue, the input image can be a red-green-blue (RGB) colored image. The image component 142 can separate the tissue foreground pixels and the non-tissue background pixels by operating on that RGB colored image. In some cases, identifying non-tissue background pixels using the RGB colored image can be difficult. In such cases, the image component 142 can transform the RGB colored image to a greyscale image. The image component 142 can then determine, using the greyscale image, a threshold intensity that can permit distinguishing tissue foreground pixels from non-tissue background pixels. Specifically, the image component 142 can identify pixels in the greyscale image that have intensities less than the threshold intensity, and can then configure such pixels as non-tissue background pixels. The image component 142 can assign a null intensity to the non-tissue background pixels in the greyscale image; that is, the non-tissue background pixels can be configured as black pixels in the greyscale image. Hence, the image component 142 can identify pixels in the RGB colored image that correspond to the non-tissue background pixels in the greyscale image. The image component 142 can configure such identified pixels as non-tissue background pixels in the RGB colored image. After having identified non-tissue background pixels in the input image, the image component 142 can configure the non-tissue background pixels in the tissue mask image as black pixels, for example. The tissue mask image having black pixels constitutes a normalized input image. Examples of a normalized reference image 103A and a normalized displaced image 105A are shown in FIG. 1B.

The normalization module 140 also can optionally apply one or multiple shaping operations to the tissue mask image. The shaping operations can include cropping the tissue mask image to remove an undesired background section, and resizing the tissue mask image to attain defined resolution suitable for input into an alignment model described herein.

As mentioned transcriptome profiling data can be acquired from the same slide used to obtain an image of biological tissue (referred to as tissue image). Thus, the transcriptome profiling data corresponds to the tissue image and can supplement the information contained in that image. In some existing platforms, gene expression measurements can be performed on hundreds to tens of thousands of small areas of tissue, referred as spots. In some cases, a spot can cover an area spanning one cell and, thus, the measurements can have single-cell spatial resolution. In other cases, a spot can cover an area spanning a few to a few tens of cells, and, thus, the measurements can have a near single-cell spatial resolution. In ISH based platforms, messenger RNA (mRNA) transcripts can be quantified at the subcellular resolution. Nevertheless, gene expression obtained from within a single or a few cells at each spot may suffer from low mRNA transcript detections and can be sensitive to non-spatial confounding factors, such as batch effects and cell state changes.

To mitigate, or even avoid altogether, limitations arising from batch effects and cell state changes, the normalization module 140 can transform transcriptome profiling data into input data formatted as an image. To that end, the ingestion module 130 can receive spatially resolved transcriptome (ST) profiling data corresponding to a first slide of biological tissue and a second slide of biological tissue. The first slide can correspond to the reference image and the second slide can correspond to the displaced image. The transcriptome profiling data defines transcriptome profiles for respective spots within each one of the first and second slides. A position of a spot in the first slide can be defined by the position of the pixel in the reference image underlying the center of the spot, and thus is defined in the reference 2D coordinate system. A position of a spot in the second slide is defined by the position of the pixel in the displaced image at the center of that spot, and thus is not necessarily defined within the reference 2D coordinate system. Accordingly, a spot at a particular position within the second slide need not correspond to a spot at that same position in the first slide. Examples of a set of reference spot coordinates 107 and a set of displaced spot coordinates 109 are shown in FIG. 1C. As is described herein, the computing device 120 can align the displaced spatial coordinates of spots on the displaced slide relative to the 2D reference coordinate system.

The ingestion module 130 can pass (or otherwise send) the transcriptome profiling data to the normalization module 140. A transcriptome component 146 that can be part of the normalization module 140 can assemble the transcriptome profiles of all spots within a particular slide in a count matrix, such as count matrix 111 (for the reference image 103) and count matrix 113 (for the displaced image 104) shown in FIG. 1A. Columns of the count matrix 111,113 correspond to respective spot identifiers (IDs), or, in some cases, cell IDs. Rows of the count matrix 111,113 correspond to respective genes. The transcriptome component 146 can normalize the count matrix 111,113 to have equal total number of counts per column. The transcriptome component 146 can then natural-log transform the count matrix 111,113. The transcriptome component 146 also can center and scale the count matrix 111,113 to have values in a range from 0 to 1. Subsequently, the transcriptome component 146 can determine the top N variable genes across the spots within the particular slide. The parameter N is configurable. In one example, N=2000.

The transcriptome component 146 can integrate transcriptome data corresponding to the first slide and the second slide. The transcriptome component 146 can scale the integrated data and can implement dimension reduction by applying principal component analysis (PCA). The transcriptome component 146 can perform a mutual nearest neighbor based clustering based on the top Mprincipal components. Resolution parameters are configured to identify major clusters. The parameter M is configurable. In one example, M=30.

After clusters have been identified, such as the clusters 115 shown in FIG. 1A, the transcriptome component 146 can generate, based on the transcriptome profiling data, a label map. The label map spans the same defined area as an input image (e.g., the reference image 103 or the displaced image 105) of the biological tissue associated with the transcriptome profiling data. The label map can include a first label associated with multiple first pixels within the input image, and a second label associated with multiple second pixels within the input image, etc. To generate the label map, the transcriptome component 146 can assign a cluster label to a pixel located at the centroid of each spot (or each cell, in single-cell resolved measurements). In some cases, the pixels of the input image can be partitioned as a Voronoi diagram using centroid pixels as generating points. The transcriptome component 146 can assign a defined cluster label, such as Cluster 1, Cluster 2, etc., as shown in clusters 115 in FIG. 1A, to pixels within each partition polygon in the Voronoi diagram, where the defined cluster label is the same as the cluster label assigned to the centroid pixel defining the generating point of the partition polygon. Such a label assignment process can be referred to as dilation of the labels.

The transcriptome component 146 can generate a contour map based on the label map that reflects transcriptome-derived spatial organization of the tissue spots (or cells, in single-cell resolved measurements). An example contour map 111A for the reference image 103 and an example contour map 113A for the displaced image 105 are shown in FIG. 1A—each having three boundaries (e.g., based on the clusters 115). To that point, boundaries between any two regions having different cluster labels can be used to define the contour map. Indeed, a first contour in the contour map defines a boundary that separates a subset of multiple first pixels having a first cluster label and a subset of the multiple second pixels having a second cluster label. In some cases, high complexity regions in the contour map (e.g., 111A and/or 113A) may be merged to avoid model overfitting.

The transcriptome component 146 can superimpose the contour map (e.g., 111A and/or 113A) with a normalized input image. For example, as shown in FIG. 1A, the contour map 111A may be superimposed on a normalized reference image 111C (e.g., normalized reference image 103A), and the contour map 113A may be superimposed on a normalized displaced image 113C (e.g., normalized displaced image 105A). Contours in the counter map (e.g., 111A and/or 113A) can be superimposed with the normalized input image at the pixels underlying the contours. To that end, the transcriptome component 146 can identify, within the normalized input image, particular pixels corresponding to each contour. The transcriptome component 146 can then update the normalized input image by modifying respective values of the particular pixels. The transcriptome component 146 can determine each value of the respective values as a linear combination of a first value from the normalized input image and a second value based on the transcriptome profiling data. The proportion of second value to the first value in the linear combination can be 0.3:0.7, for example.

Transforming transcriptome data into a contour map and incorporating the contour map into a tissue image can permit minimizing the impact of noise and batch effect on the alignment of a pair of images of biological tissue. The contour map derived from transcriptome data as is described herein provides orthogonal supplementary information to a tissue image, especially in cases where the tissue image is homogenous and thus lacks information about the spatial organization/orientation of the slide that is the source of the image. Notwithstanding, normalization of a reference image and displaced image to superimposed a contour map based on transcriptome data is optional. Indeed, utilization transcriptome data may be undesired in some scenarios, such as when tissue image contains sufficient regional texture details, transcriptome data has low quality, and the like.

The normalization module 140 can pass (or otherwise send) the normalized reference image 111C and the normalized displaced image 113C to a transformation module 150. As is illustrated in FIG. 1, the transformation module 150 can be included in the computing device 120. The transformation module 150 can perform two types of alignment of the normalized displaced image 113C relative to the normalized reference image 111C. To that end, an affine registration component 154 that is part of the transformation module 150 can perform a first registration of the normalized displaced image 113C relative to the normalized reference image 111C. The first registration can provide a coarse alignment of the normalized displaced image 113C relative to the 2D reference coordinate system associated with the reference image 103. Performing the first registration can include determining an affine transformation can be determined between the normalized displaced image 113C and the normalized reference image 111C. Determining the affine the affine transformation includes determining a group of parameters defining that transformation. As a result of performing the first registration, the affine registration component 154 can determine a first deformation vector field associated with the affine alignment based on the affine transformation. Such a first deformation vector field can define new locations that respective pixels of the normalized displaced image 113C are to move to in order for the normalized displaced image 113C to be at least partially aligned with the normalized reference image 111C. The transformation module 150 can retain the first deformation vector field within the memory 170 (shown in FIG. 1A as deformation vector field(s) for spot alignment 151).

As part of applying the first registration, an alignment module 160 can apply the first deformation vector field to the normalized displaced image 113C. As a result, the alignment module 160 can generate a second displaced image (not shown). The alignment module 160 can pass (or otherwise send) the second displaced image to the transformation module 150. The transformation module 150 can receive the second displaced image, and can then supply the normalized reference image 111C and the second displaced image to a dense registration component 156. The dense registration component 156 can perform a second registration of the second displaced image relative to the reference image 103 by applying an alignment model 158 to the normalized reference image 111C and the second displaced image. Applying the alignment model in such a fashion can yield a second deformation vector field representative of a registration transformation between the reference image and the second displaced image. The dense registration component 156 can be configured (e.g., program coded and built) to include the alignment model 158. As an alternative, in some embodiments, the dense registration component 156 can load or otherwise obtain the alignment model 158 from the memory 170. To that end, in such embodiments, the memory 170 can retain the alignment model 158.

As part of applying the alignment model 158, the dense registration component 156 can determine a corresponding inverse deformation vector field by integrating the negated gradient of the deformation vector field (also referred to as the negative flow). The alignment module 160 can then apply the inverse deformation vector field to the second displaced image, resulting in an aligned normalized image.

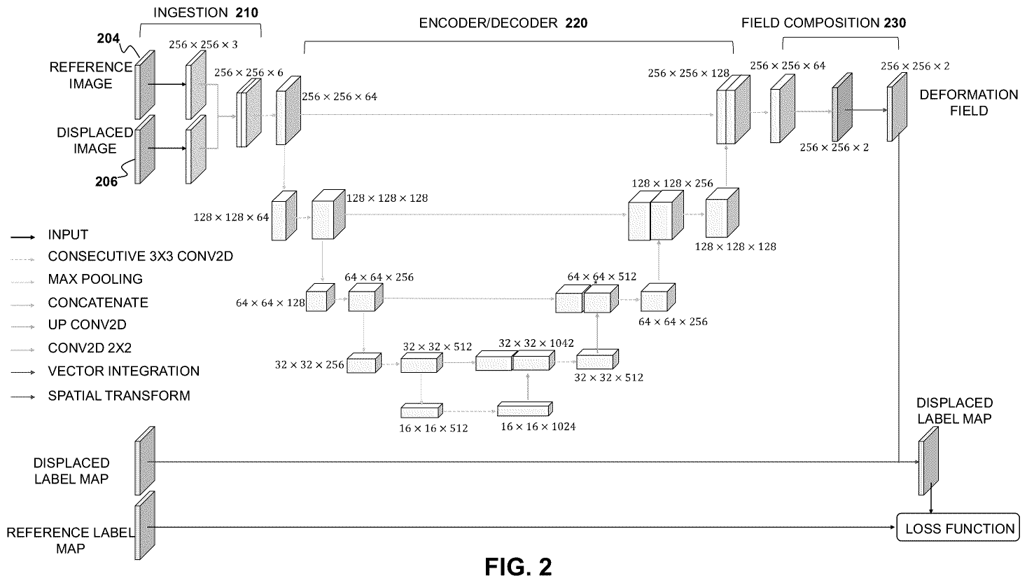

The alignment model 158 can be a machine-learning model that includes a neural network having one or more first layers of a first type and one or more second layers of a second type. The one or more first layers can be configured to extract features from the normalized reference image and the second displaced image. The one or more second layers can be configured to output the deformation vector field and the inverse deformation vector field corresponding to the deformation vector field. In some cases, as is illustrated in FIG. 2, the machine-learning model can be include a convolutional neural network (CNN) 200 having an ingestion module 210; an encoder-decoder block 220 including an encoder module for feature extraction, a single bottleneck level representing a latent space, and a decoder module; and a field composition module 230 configured to output the deformation vector field and the inverse deformation vector field. The ingestion module permits concurrently receiving imaging data defining a reference image 204 and imaging data defining a displaced image 206. The reference image and the displaced image can both be normalized images in accordance with aspects described herein. Simply for purposes of illustrations, in the CNN 200 the ingestion module 210 is embodied in a Siamese input processor, and the encoder-decoder block 220 is embodied in a U-Net backbone. Additionally, the CNN 200 is illustrated as being configured for images having sizes of 256×256 pixels. This disclosure is, of course, not limited in that respect, and other image sizes can be contemplated. The encoder module includes four levels of downsampling (or contracting), and the decoder module includes four levels of upsampling (or expanding). Skip connections from the encoder module to the decoder module also are included at each level. The final level of the decoder module is connected to the field composition module to output the deformation field to align an input displaced image or a set of displaced coordinates of spots on the displaced slide where transcriptome profiles are obtained to an input reference. It is noted that the disclosure is not limited to a U-Net backbone. Indeed, other CNNs can form part of the alignment model, where each one of those CNNs includes a module (e.g. a visual transformer) that can perform feature extraction from imaging data and can map the extracted features to a deformation field and a corresponding inverse deformation field.

As an example, a component of the alignment model 158, such as the encoder module of the encoder-decoder block 220, may perform feature extraction from imaging data as a pre-training step or process. In addition to using transcriptome profiles for an input reference, or when transcriptome profiles for an input reference are unavailable, the encoder module may use self-supervised learning (e.g., label-less learning) to extract features from an input reference (e.g., a raw histological image(s)) and map those extracted features, as described herein, to a deformation field and a corresponding inverse deformation field. The encoder module may use such self-supervised pre-training to augment existing feature extraction capabilities/functionality of the encoder described herein. For example, the encoder module may use representation learning, masked image modeling, a combination thereof, and/or the like to autonomously identify and interpret patterns within an input reference by predicting one or more features (e.g., associated with a first portion) using other features derived therefrom (e.g., associated with another portion(s)). The encoder module's use of self-supervised learning may improve alignment performance with higher precision. Moreover, the encoder module's use of self-supervised learning for feature extraction combined with subsequent supervised fine-tuning on synthetic data as further described herein, may improve model accuracy and precision as well.

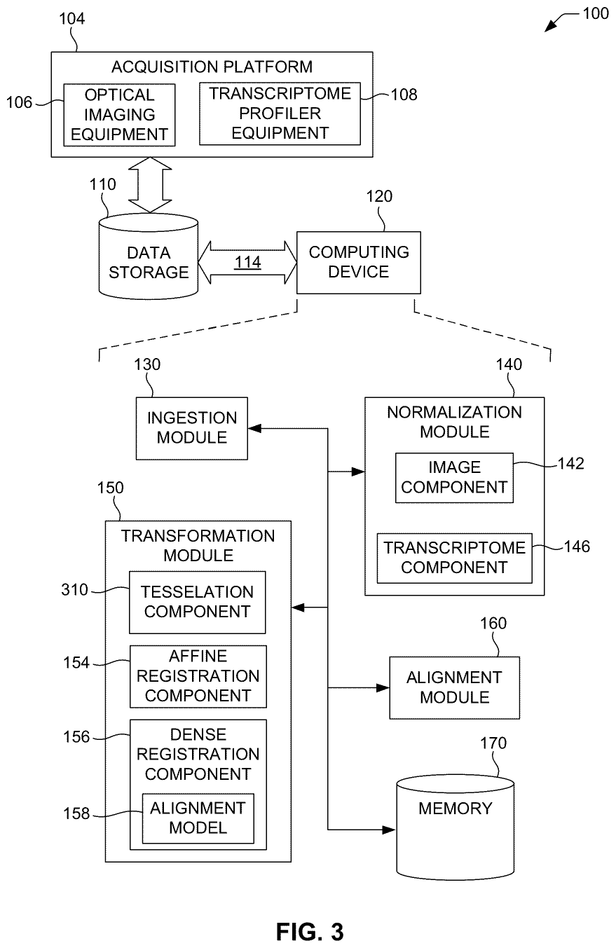

The alignment model 158 can be configured to receive images having a defined size, e.g., Nₚ×Nₚ pixels. In one example, Nₚ=256. The ML-based alignment described herein, however, is not limited in that respect. Indeed, in some embodiments, the computing device 120 can align images having sizes greater than the defined size. To that end, as is shown in FIG. 3, the transformation module 150 can partition an input image into sections having the defined size. To that end, the transformation module 150 can include a tessellation component 310 that can generate a tiling of an input image having a size equal to Mₚ×Mₚ, with Mₚ>Nₚ, prior to the registration of the input image.

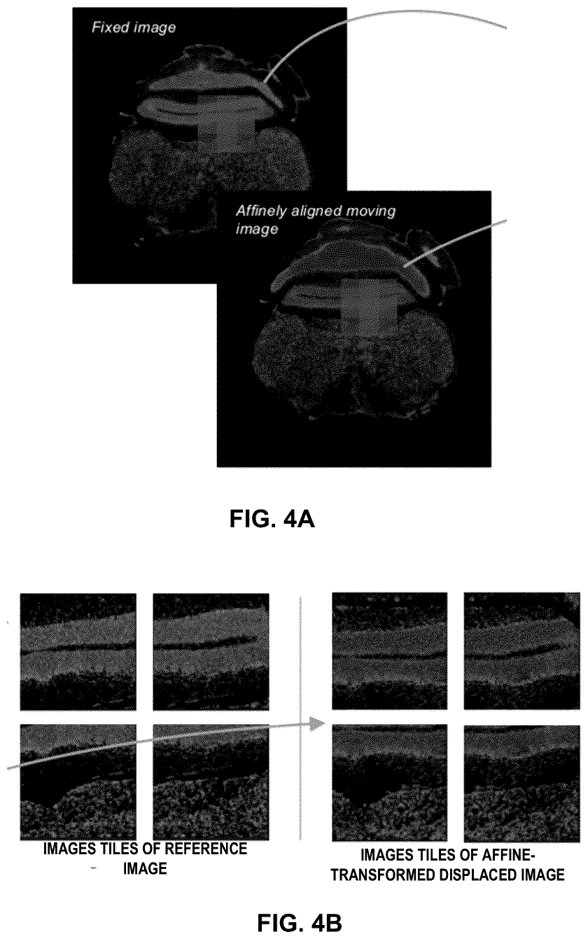

More specifically, in cases where each one of a reference image and displace image has size Mₚ×Mₚ, the tessellation component 310 can generate a tiling of the normalized reference image. Each tile image of the tiling of the normalized reference image has an identical size that matches the defined size Nₚ×Nₚ. he tile images can be evenly spaced along the width and along the height of the normalized reference image. As is shown in FIG. 4A, each tile image of the tiling of the normalized reference image partially overlaps spatially with every other tile image adjacent to the tile image. In some cases, there can be a minimum of two adjacent tile images and maximum of four adjacent tile images. FIG. 4B illustrates examples of image tiles of the reference image (or fixed image) and image tiles of the affine-transformed displaced image shown in FIG. 4A.

Rather than operating on an input displaced image, the tessellation component 310 can generate a tiling of the second displaced image. The tiling of the second displaced image can be generated in the same fashion as the tiling of the reference image. As such, the tiling of the second displaced image has the same structure as the tiling of the reference image. Accordingly, there are the same total number of tile images on the tiled second displaced image and the normalized reference image. Each tile image in the tiling of the second displaced image has one and only one matching tile image in the tiling of the normalized reference image that covers an identical spatial area in the second displaced image and the normalized reference image, respectively.

The tile images of the tiling of the normalized reference image and the tile images of the tiling of the second displaced images can be supplied to the alignment model 158. The tile images can be supplied in sequence, supplying at the same time a pair of tile images, where the pair of tile images consists of a tile image of the normalized reference image and a tile image of the tiling of the second displaced image that matches the tile image from the normalized reference image in terms of placement and size. That is, both tile images in the pair cover the same spatial area in their respective full images.

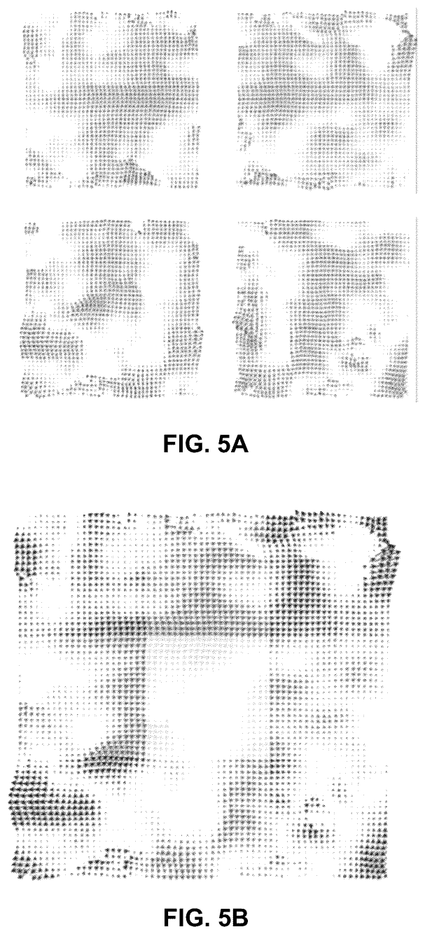

The transformation module 150, via the dense registration component 156, can apply the alignment model 158 to each tile image of the tiling of the normalized reference image, together with a tile image of the tiling of the second displaced image that matches the tile image in the normalized reference image as is described above. As a result, the application of the alignment model 158 can yield N_{T} tile deformation vector fields, where N_{T} denotes the total number of tiles of the tiling of the normalized reference image which is equivalent to the total number of tiles of the tiling of the second displaced image. FIG. 5A illustrates an example of four tile deformation vector fields.

The alignment module 160 can join the N_{T} tile deformation vector fields to form a deformation vector field corresponding to the displaced image having size Mₚ×Mₚ. Each one of the N_{T} tile deformation fields and every one of its adjacent tile deformation fields have a defined region in common. Hence, the alignment module 160 can join the N_{T} tile deformation vector fields by determining, for each pixel within the defined region in common, a weighted average of the tile deformation vector fields overlapping at that pixel, and assigning, for each pixel within the defined region in common, the weighted average to the deformation vector field. In some cases, the numerical weight applied to a tile deformation field at a particular pixel is inversely proportional to the distance between the center of that tile deformation field and the particular pixel. FIG. 5B illustrates an example of deformation vector field resulting joining multiple tile deformation vector fields in accordance with aspects described herein.

The alignment model 158 may be trained in a tissue-agnostic manner using synthetic training data. In that way, the alignment model 158 can be applicable to any tissue type and/or image acquisition protocols—e.g. various histology staining techniques, non-histology fluorescence-based IHC imaging, and ISH imaging. Additionally, using synthetic training data can addresses the issue of limited training data availability that is common in deep neural network training. In contrast to existing technologies, the approach to image synthesis that is described herein is devised for the tissue alignment task solved by embodiments of this disclosure.

Each instance of a training data record contains a quartet of synthetic images: (a) a colored reference image, (b) a first segmentation mask image associated with the colored reference image, (c) a colored displaced image to be aligned with the colored reference image, and (d) and a second segmentation mask image associated with the colored displaced image. In this disclosure, a segmentation mask image can be referred to as a label map. Pixels in the segmentation mask image can be classified into a finite number of distinct classes, with each pixel being assigned a specific class label. Those classes can be abstract regarding the training data, but can reflect spatially segregated regions of tissue microenvironment and/or cell compositions in the context of a tissue slide.

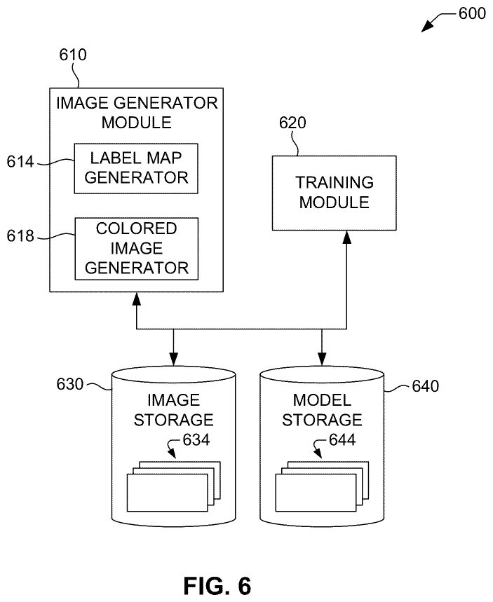

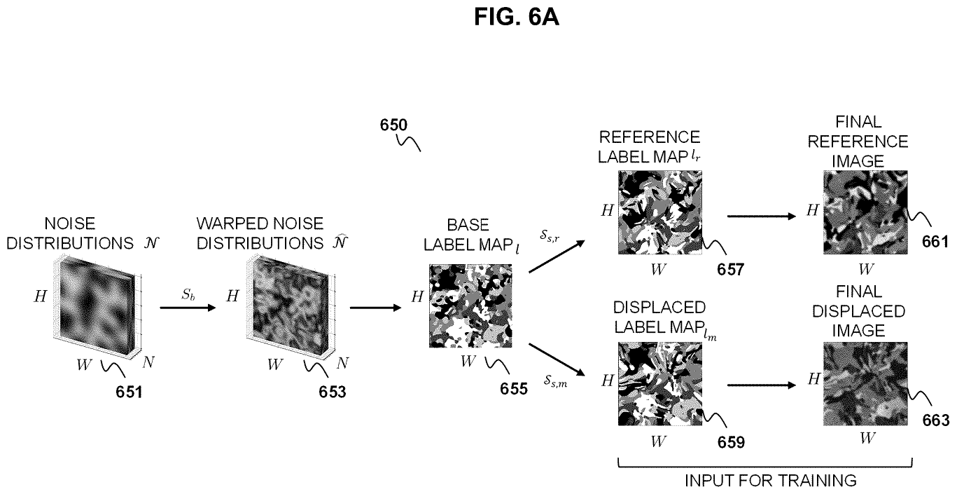

FIG. 6 illustrates an example computing system 600 to train an alignment model, such as the alignment model 158, using synthetic images. The computing system 600 includes an image generator module 610 that can generate multiple quartets of synthetic images in order to create training data to train the alignment model. The image generator module 610 can generate multiple pairs of training images, wherein each pair of the multiple pairs of training images comprises a training reference image and a training displaced image. The multiple pairs of training images can be generated based on multiple label maps.

More specifically, for a particular quartet of synthetic images, the image generator module 610 can include a label map generator component 614 (referred to as label map generator 614) that can configure labels for respective pixels spanning an area of a defined size. The labels can be configured for multiple layers corresponding to the area of the defined size. Specifically, the labels include multiple sets of labels for respective ones of the multiple layers. That is, for N_{L} layers, a first set of labels corresponds to a first layer, a second set of labels corresponds to a second layer, and continuing up to an N_{L}-th set of labels that corresponds to an N_{L}-th layer. In one example, N_{L}=5. Accordingly, the generator module 310 can assign N_{L} labels to each pixel within the area of the defined size, where each one of the N_{L} labels corresponds to a respective layer. Each layer can be referred as a channel.

The labels within a layer can be configured at random. To that end, the label map generator 614 can configure multiple arbitrarily seeded simplex noise distributions within respective layers. As a result, for a layer, at each pixel within the area of the defined size, a label can have a numerical weight associated therewith. The label map generator 614 can determine the numerical weight as a random value according to the simplex noise distribution for that layer, at that pixel. As such, the label map generator 614 can determine, using such simplex noise distributions, respective numerical weights for multiple defined labels at a particular pixel within the area. The label map generator 614 can then assign, to the particular pixel, a first label corresponding to a first numerical weight having the greatest magnitude among the respective numerical weights.

Based on the configured labels, the label map generator 614 can generate a base label map that spans the area of the defined size. The label map generator 614 can then generate a reference label map by warping, using a simplex noise field as warping field, the base label map. Such warping can be referred to as first simplex noise warping. In addition, the label map generator 614 also can generate a displaced label map by warping, using another simple noise field as warping field, the base label map. Such warping can be referred to as second simplex noise warping.

The image generator module 610 can include a colored image generator component 618 (referred to as colored image generator 618) that can generate, based on the reference label map, a particular training reference image. To that end, for each label in the first label map, the colored image generator 618 can randomly select a color (e.g., an RGB color) for the label, and can then configure a group of pixels corresponding to the label to have the selected color. As a result, the colored image generator 618 produces a colored image. In addition, the colored image generator 618 can operate on the colored image to yield the particular training reference image. Operating on the colored image can include blurring the colored image, resulting in a blurred image, and applying a bias intensity field to the blurred image. The blurring that is applied to the colored image can be Gaussian blurring. Bias intensity field spans the area of the defined size.

The colored image generator 618 also can generate, based on the displaced label map, a particular training displaced image. To that end, for each label in the second label map, the colored image generator 618 can randomly select a color (e.g., an RGB color) for the label, and can then configure a group of pixels corresponding to the label as having the selected color. As a result, the colored image generator 618 produces a colored image. In addition, the colored image generator 618 can operate on the colored image to yield the particular training image. As is described herein, operating on the colored image can include blurring the colored image, resulting in a blurred image, and applying a bias intensity field to the blurred image. The blurring that is applied to the colored image can be Gaussian blurring. The bias intensity field spans the area of the defined size.

The image generator module 610 can configure the reference label map, the displaced label map, the particular training reference image, and the particular training displaced image, as pertaining to a particular instance of a training data record. The image generator module 610 can retain the first label map, the second label map, the particular training reference image, and the particular training displaced image as part of synthetic images 634 within one or more memory devices 630 (referred to as image storage 630).

FIG. 6A schematically depicts an example process flow 650 to generate (e.g., via the image generator module 610) the reference label map and the displaced label map and to generate a synthetic training reference image and a synthetic training displaced image in accordance with aspects described herein. Noise distributions [symbol] 651 may comprise N layers of 2-D Simplex noise of height H and width W. Each layer nᵢ of the noise distributions [symbol] 651 may correspond to a class label. As shown in FIG. 6A, a collection of Simplex noise distribution Sb having of shape (H, W) corresponding to the noise distributions [symbol] 651 may be applied to each layer nᵢ of the noise distributions [symbol] 651 to form warped noise distributions [symbol] 653. Next, the warped noise distributions [symbol] 653 may be condensed along the dimension N to form a 2-D base label map l 655 of shape (H, W). Each pixel of the base label map l 655 may be assigned a class label cᵢ (not shown) where a layer nᵢ may have a highest intensity at the position corresponding to that pixel. The base label map l 655 may be further warped by separate Simplex noise [symbol] _{s,r} and [symbol] _{s,m} to create a reference label map lᵣ 657 and a displaced label map lₘ 659, respectively. A final reference image 661 (e.g., a synthetic training reference image) and a final displaced image 663 (e.g., a synthetic training displaced image) may be generated based on the reference label map lᵣ 657 and the displaced label map lₘ 659. For example, the final reference image 661 and the final displaced image 663 may be generated by assigning an RGB color to each of the class labels associated with the base label map l 655. The final reference image 661, the final displaced image 663, the reference label map lᵣ 657, and the displaced label map lₘ 659 may represent (e.g., as a group) one sample in the training dataset. That is, the final reference image 661, the final displaced image 663, the reference label map lᵣ 657, and the displaced label map lₘ 659 may represent one of the multiple quartets of synthetic images as described herein.

The computing system 600 can include a training module 620 that can train an alignment model based on multiple label maps and multiple pairs of training images (e.g., generated via the process flow 650) for registration of an evaluation displaced image of biological tissue relative to an evaluation reference image of the biological tissue. As is described herein, the alignment model can be a machine-learning model that includes a convolutional neural network (e.g., CNN 200 (FIG. 2)) having an encoder module for feature extraction; a single bottleneck level representing a latent space; a decoder module; and a field composition module configured to output the deformation vector field and the inverse deformation vector field corresponding to the deformation vector field. The field composition module also can be referred to as deformation field former module. In some examples, as described herein, the encoder module for feature extraction may perform feature extraction from imaging data, such as the evaluation reference image of the biological tissue, as a pre-training step or process. In addition to using a transcriptome profile(s) for the evaluation reference image, or when a transcriptome profile(s) for the evaluation reference image is unavailable, the encoder module may use self-supervised learning (e.g., label-less learning) to autonomously identify and interpret patterns within the evaluation reference image by predicting one or more features (e.g., associated with a first portion) using other features derived therefrom (e.g., associated with another portion(s)).

To train the alignment model, the training module 620 can iteratively determine a solution to an optimization problem with respect to a loss function based on a similarity metric of a pair of label maps and a deformation vector field associated with a training reference image and a training displaced image. Such a solution defines a trained machine-learning alignment model. More specifically, the loss function can be defined as

L(m,f)=−Dice(sₘ,s_{f})+λ_{reg}∇\vec{u}, (1)
where f, s_{f} represent a training reference image and the reference label map associated with that image, respectively. Additionally, m and sₘ represent, respectively, a displaced image and the displaced label map associated with that image, after applying the inferred deformation vector field \vec{y}, output by the alignment model. The parameter λ_{reg} is a regularization factor, and ∇\vec{u} is the gradient (that is, magnitude of change) of the inferred deformation vector field \vec{u}

In Eq. (1), the regularization term λ_{reg} ∇\vec{u} discourages abrupt large deformations. The dice score Dice(sₘ, s_{f}) is a similarity metric that assesses agreement of the pixel-wise class labels between the reference label map and displaced label map, instead of the pixel-wise color and intensity agreement between the training reference image and the training displaced image. The loss function L(m, f) suits the fact that the tissue slides to be aligned are not expected to be identical regarding fine grain details, such as the position of individual cells/nuclei. Instead, the matching is regarding the regions of cells.

The training module 620 can retain the trained alignment model in a library of alignment models 644 within one or more memory devices 640 (referred to as model storage 640). The training module 620 also can configure an interface, such as an API, to permit access to the stored trained alignment model via a function call.

In embodiments of this disclosure, a trained alignment model (such as the alignment model 158) can infer conservative deformations in each inference execution (e.g., application of the trained alignment model to a pair of evaluation images). Accordingly, a computing device (e.g., computing device 120 (FIG. 1)), or, in some cases, a system of computing devices, can apply the trained alignment model multiple times to the pair of evaluation images until displaced coordinates are stable or a defined number of iterations is reached (e.g., 5 iterations). The defined number of iterations can be configurable based on user-specified input. The displaced coordinates can be considered stable when the mean square error between current coordinates in the n-th iteration and those from the previous (n−1)-th iteration is smaller than a defined percentage (e.g., 1%) of the mean square error between the (n−1)-th iteration and the (n−2)-th iteration.

In embodiments of this disclosure, more than two slides can be aligned either in a “template-based” mode or a “template-less” mode. The template-based mode incudes configuring one of the slides as the fixed reference, and aligning the remaining slides relative to that fixed reference. The operation of aligning a pair of slides described herein can be applied to each of the non-reference slides to generate a set of aligned tissue slides.

The “template-less” mode includes scaling and centering each slide such that the spot coordinates detected on each slide are within the same range along the x axis and y axis. For example, assuming a spatial transcriptome slide size is 512×512, the minimum (x,y) coordinates of spots in each slide can be at (35, 35) and the maximum (x, y) spot coordinates in each slide can be no greater than (477, 477). The “template-less” mode also includes, for each slide sᵢ among Nₛ total slides, performing a pair-wise alignment by applying a trained alignment model on sᵢ using each of the (Nₛ−1) remaining slides sⱼ (j≠i) as fixed references. The resulting (N−1) sets of aligned coordinates together with the initial coordinates of sᵢ (assuming it is aligned to itself and thus no change) can be averaged and output as the final post-alignment coordinates of the slide sᵢ.

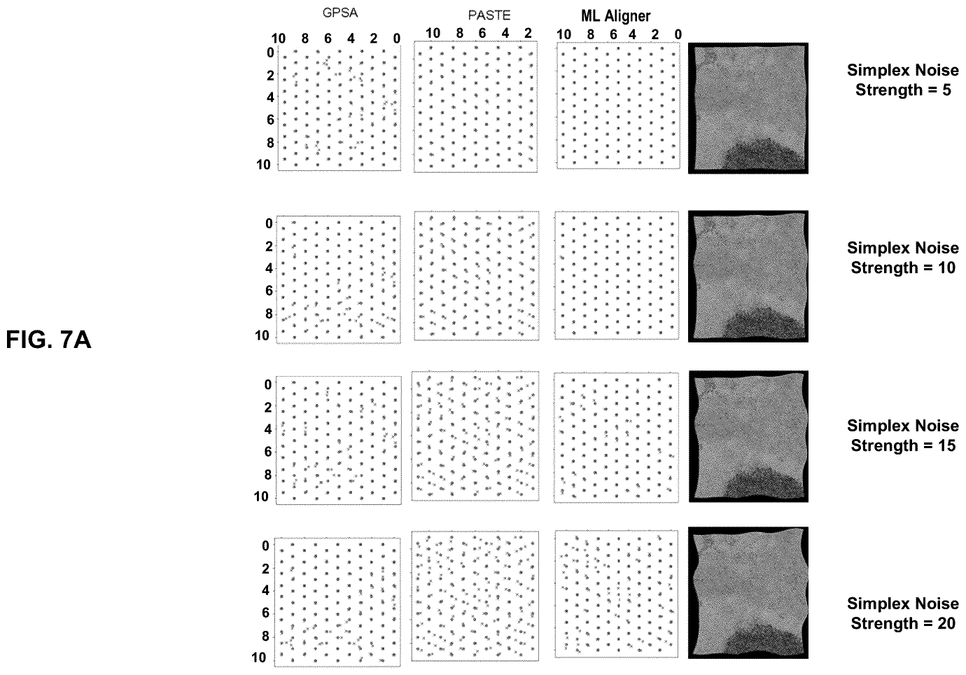

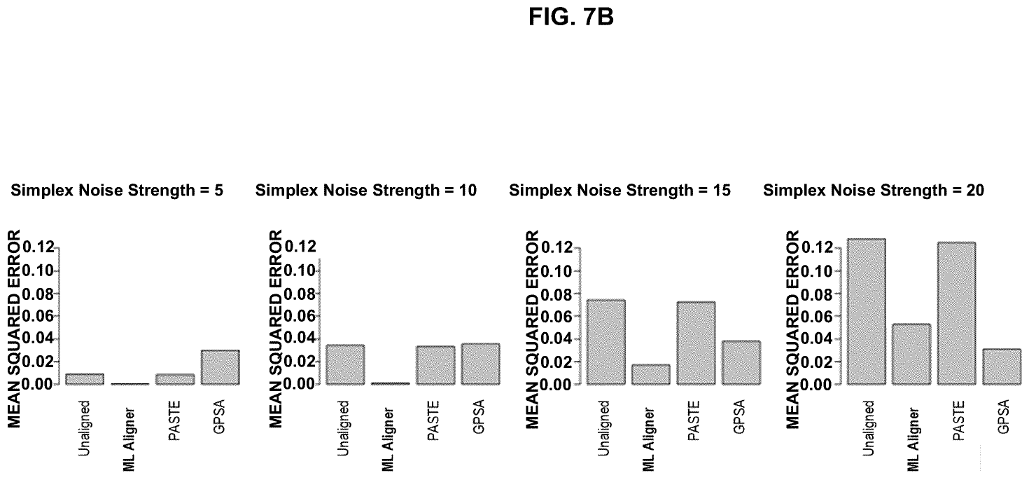

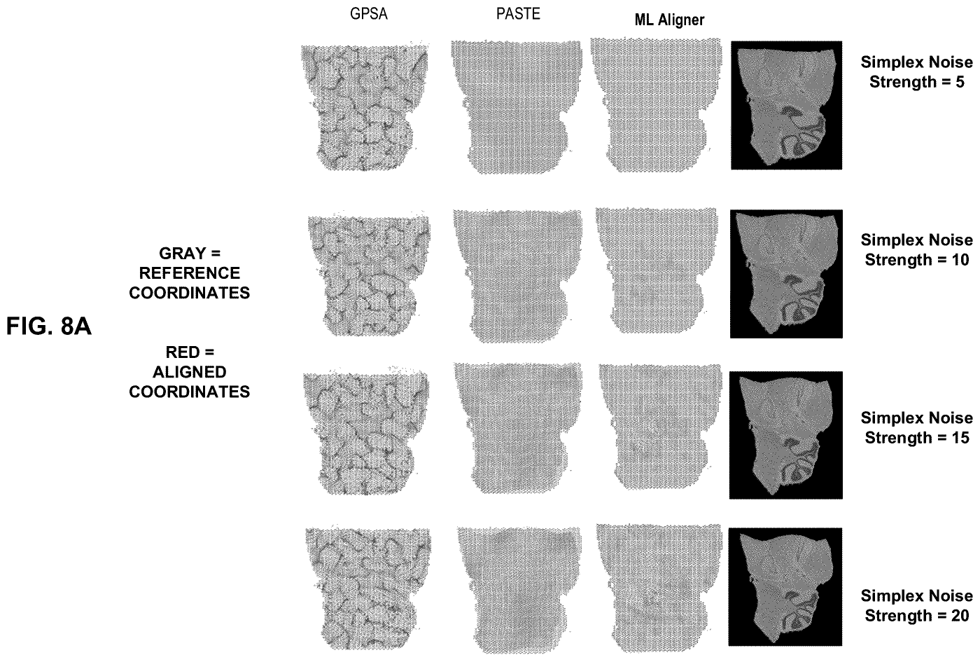

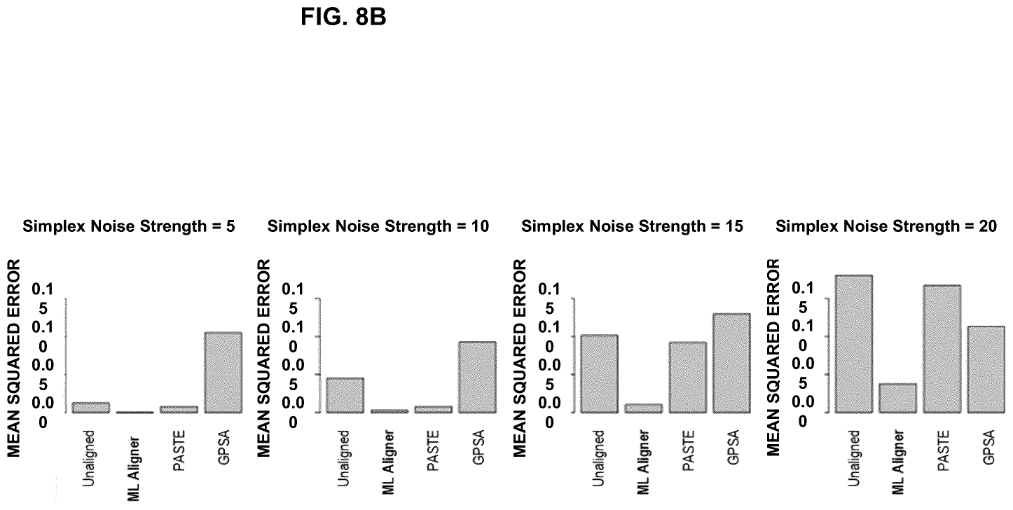

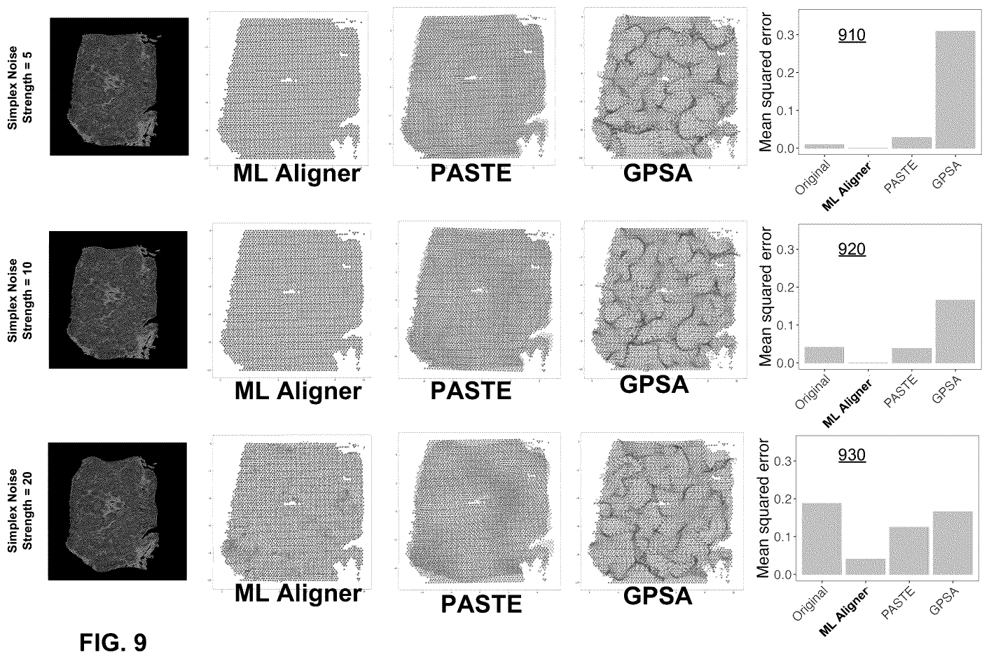

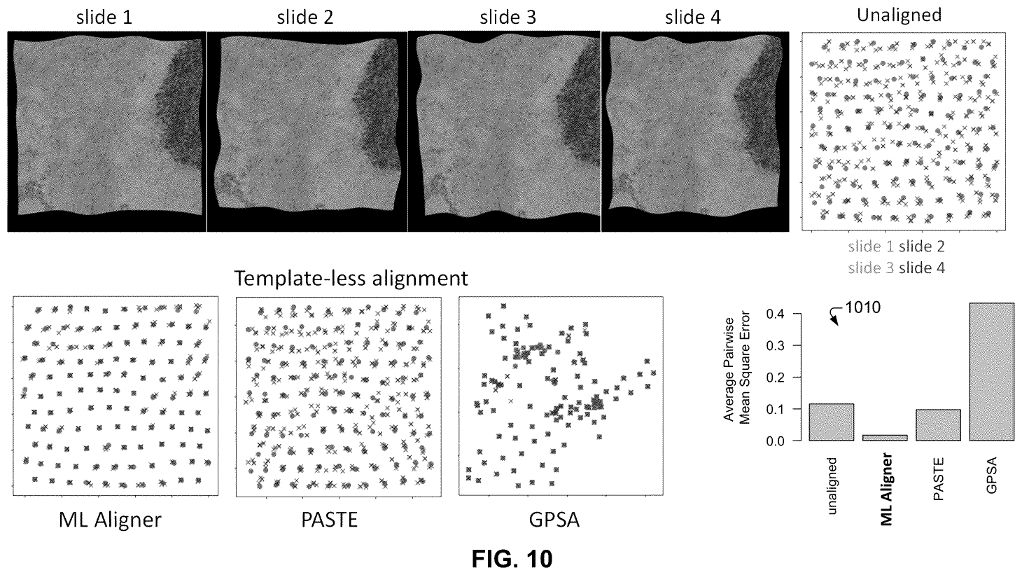

FIGS. 7-10 illustrate alignment performance in various scenarios having different slide types and arrangements of slides, in accordance with embodiments of this disclosure. In some of the performance results, the embodiments of this disclosure have been generically denoted as “ML Aligner” simply for the sake of nomenclature. More specifically, FIGS. 7A and 7B illustrate examples of alignment performance for small slides, in accordance with embodiments of this disclosure. Such small slides each have 115 spots. Alignment performance is measured in terms of mean square error (MSE). For each Simplex noise strengths of 5, 10, and 15, performance of the ML Aligner is superior to the performance of existing technologies for alignment slides. Without intending to be bound by interpretation, it is noted that while GPSA for simplex noise strength of 20 yields a MSE that is less than the MSE yielded by ML Aligner for such a strength, the improved performance of GPSA appears to be an artifact in that case. More specifically, the number of spots in a small slide appear to ease the limited sensitivity of GPSA in distinguishing spots with similar transcriptome profiles for simplex noise strength of 20. FIGS. 8A and 8B illustrate examples of alignment performance for full spatial slides, in accordance with embodiments of this disclosure. Such full spatial slides have about 3000 spots. For all illustrated Simplex noise strengths, performance of the ML Aligner is superior to the performance of existing technologies for alignment slides. Again with reference to simplex noise strength of 20, it is noted that GPSA limitations with respect to distinguishing spots with similar transcriptome profiles may yield lesser performance relative to ML Aligner. FIG. 9 illustrates an example of alignment performance for full spatial slides of human lymph node, in accordance with embodiments of this disclosure. Regardless of the amount of warping, performance of the ML Aligner is superior to the performance of existing technologies for alignment slides, as is shown in bar chart 910, bar chart 920, and bar chart 930. FIG. 10 illustrates an example of alignment performance for more than two slides. Slides are unordered, corresponding to repeated samples. As is shown in in the bar chart 1010, performance of the ML Aligner is superior to the performance of existing technologies for alignment slides.

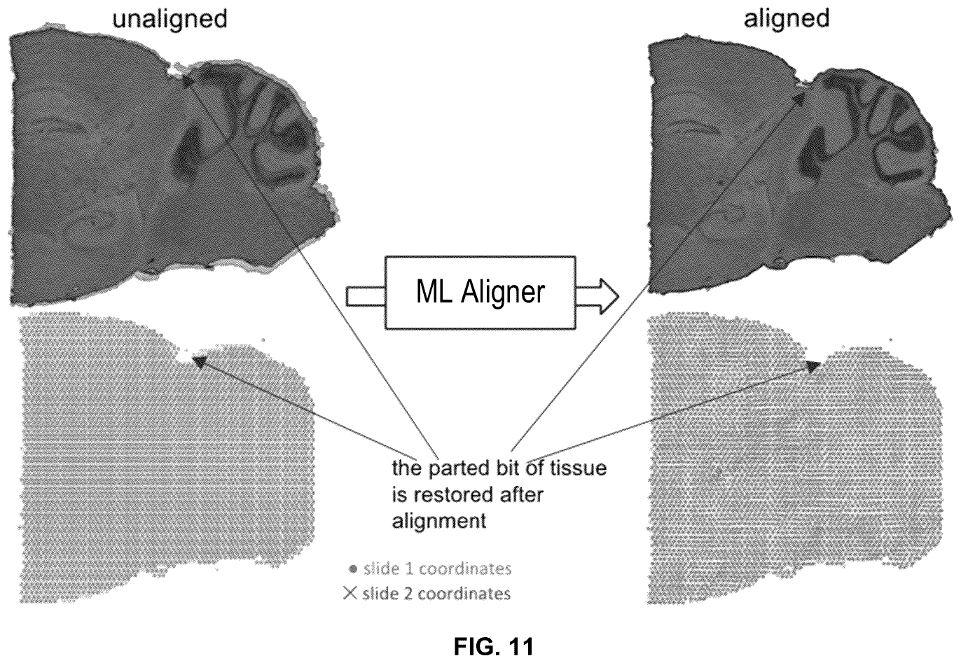

FIG. 11 illustrates an application of an alignment model in accordance with embodiments of this disclosure to the alignment of two images of a mouse brain. The images correspond to consecutive slices/slides of the mouse brain.

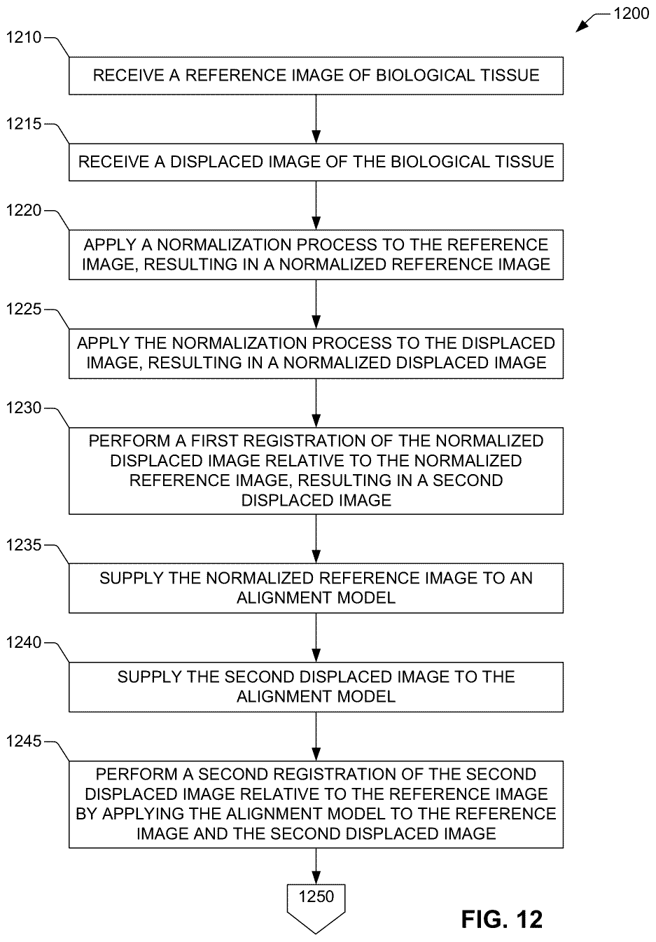

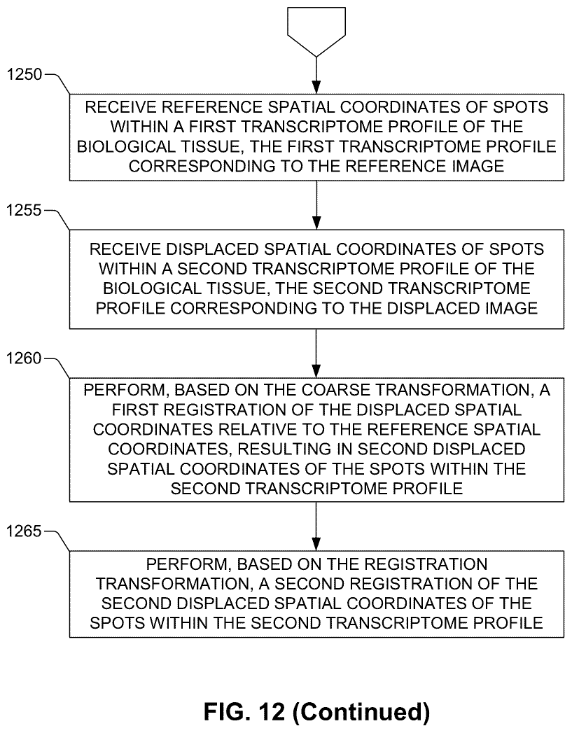

In view of the aspects described herein, example methods that may be implemented in accordance with this disclosure can be better appreciated with reference, for example, to the flowcharts in FIGS. 12-17. For the sake of simplicity of explanation, the example methods disclosed herein are presented and described as a series of blocks (with each block representing an action or an operation in a method, for example). However, the example methods are not limited by the order of blocks and associated actions or operations, as some blocks may occur in different orders and/or concurrently with other blocks from those that are shown and described herein. Further, not all illustrated blocks, and associated action(s), may be required to implement an example method in accordance with one or more aspects of the disclosure. Two or more of the example methods (and any other methods disclosed herein) may be implemented in combination with each other. It is noted that the example methods (and any other methods disclosed herein) may be alternatively represented as a series of interrelated states or events, such as in a state diagram.

The methods in accordance with this disclosure can be retained on an article of manufacture, or computer-readable non-transitory storage medium, to permit or facilitate transporting and transferring such methods to a computing device or system of computing devices (such as a desktop computer; a laptop computer; a blade server; or similar) for execution, and thus implementation, by one or more processors of the computing device(s) or for storage in one or more memory devices thereof or functionally coupled thereto. In one aspect, one or more processors, such as processor(s) that implement (e.g., execute) one or more of the disclosed methods, can be employed to execute program code (e.g., processor-executable instructions) retained in a memory device, or any computer- or machine-readable medium, to implement one or more of the disclosed methods. Such program code can provide a computer-executable or machine-executable framework to implement the methods described herein.

FIG. 12 is a flowchart of an example method 1200 for aligning images and spatial coordinates of spots within the transcriptome profile of biological tissue to a common coordinate system, in accordance with one or more embodiments of this disclosure. As is described herein, the images can be histological staining images, IHC images, or ISH images (such as FISH images). A computing device or a system of computing devices can implement the example method 1200 in its entirety or in part. To that end, each one of the computing devices includes computing resources that may implement at least one of the blocks included in the example method 1200. The computing resources comprise, for example, CPUs, GPUs, tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In one example, one or more of the computing systems may include programming interface(s); an operating system; software for configuration and/or control of a virtualized environment; firmware; and similar resources. The system of computing devices can be referred to as a computing system.

In some cases, the computing device that implements the example method 1200 can host the ingestion module 130, the normalization module 140, the transformation module 150 (including the tessellation component 310, in some cases) and the alignment module 160, amongst other software components/modules. The computing device can implement the example method 1200 by executing one or multiple instances of one or a combination of the ingestion module 130, the normalization module 140, the transformation module 150 (including the tessellation component 310, in some cases) and the alignment module 160, for example. Thus, in response to execution, the ingestion module 130, the normalization module 140, the transformation module 150 (including the tessellation component 310, in some cases) and the alignment module 160, individually or in combination, can perform the operations corresponding to the blocks, individually or in combination, of the example method 1200.

At block 1210, the computing device can receive a reference image of the biological tissue. The reference image can be obtained via optical imaging of a reference slide of the biological tissue. At block 1215, the computing device can receive a displaced image of the biological tissue. The displaced image also can be obtained via optical imaging of a displaced slide of the biological tissue. The reference slide and the displaces slide can be obtained by consecutively slicing an organ of a subject, for example. As is described herein, a position of a pixel within the reference image can be defined with respect to a reference 2D coordinate system, and a position of a pixel within the particular displaced image need not be defined within the reference 2D coordinate system. Accordingly, a pixel at a particular position within the displaced image need not correspond to a pixel at that same position in the reference image.

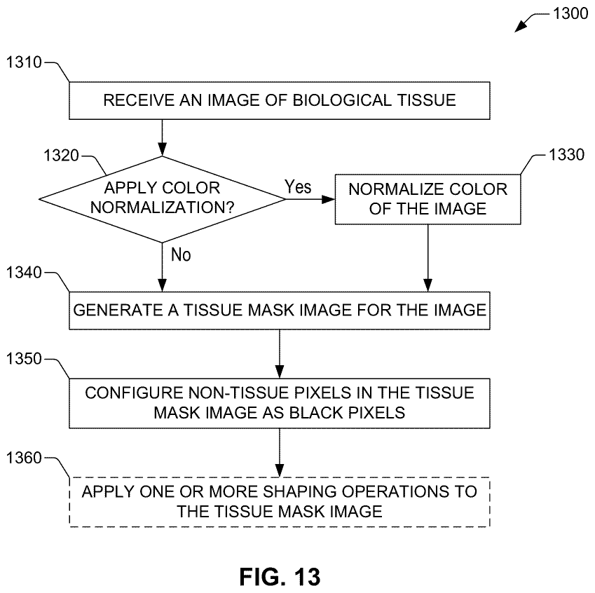

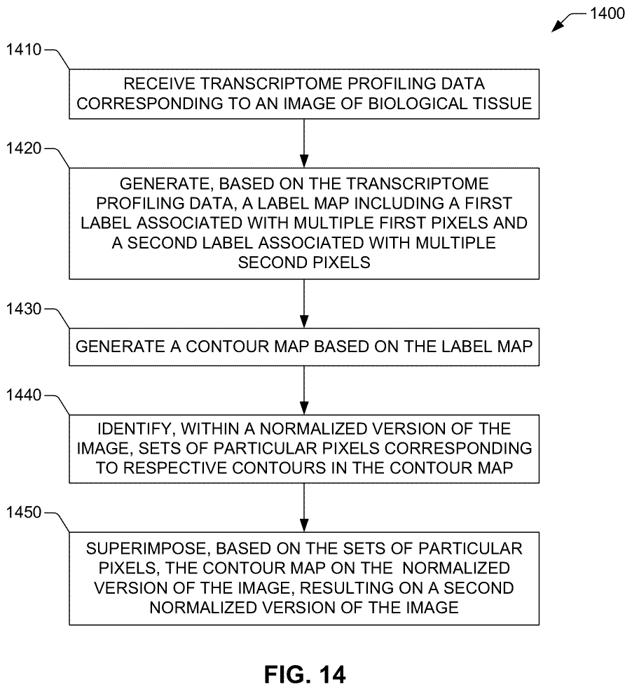

At block 1220, the computing device can apply a normalization process to the particular reference image, resulting in a normalized reference image. At block 1225, the computing system can apply the normalization process to the displaced image, resulting in a normalized displaced image. The normalization process can include various operations involving a tissue image and, optionally, transcriptome profiling data acquired on a same slide used to obtain the tissue image. To apply the normalization process to the reference image and the displaced image, the computing device can implement the example method 1300 (FIG. 13) and, optionally, the example method 1400 (FIG. 14) described hereinafter. When implementing those example methods, the reference image and the displaced image individually serve as input tissue image in respective applications of the normalization process.

At block 1230, the computing device can perform a first registration of the normalized displaced image relative to the normalized particular reference image. As is described herein, performing the first registration comprises determining a coarse transformation between the normalized displaced image and the normalized reference image. Performing such a first registration results in a group of parameters defining coarse transformation, and also results in a second displaced image. The coarse transformation can be an affine transformation, for example.

At block 1235, the computing device can supply the reference image to an alignment model. At block 1240, the computing device can supply the second particular displaced image to the alignment model. The reference image and the second displaced image can be concurrently supplied to the alignment model. The alignment model can be an ML model that has been trained using synthetic images. The alignment is thus tissue-agnostic. The ML model includes a neural network having one or more layers configured to extract features from the normalized reference image and the second displaced image, and one or more second layers configured to output a deformation vector field and an inverse deformation vector field corresponding to the deformation vector field. In some cases, ML model includes a CNN (e.g., CNN 200 (FIG. 2)). The deformation vector field is representative of a registration transformation between the reference image and the second displaced image. In one example, the alignment model is the alignment model 158 (FIG. 1).

At block 1245, the computing device can perform a second registration of the second displaced image relative to the reference image by applying the alignment model to the reference image and the second displaced image, wherein the applying yields a deformation vector field representative of a registration transformation between the reference image and the second displaced image. As part of applying the alignment model, the computing device (via the dense registration component 156 (FIG. 1), for example) also can determine a corresponding inverse deformation vector field by integrating the negated gradient of the deformation vector field (also referred to as the negative flow).

At block 1250, the computing device can receive reference spatial coordinates of spots within a first transcriptome profile of the biological tissue. The first transcriptome profile corresponds to the reference image. Indeed, the first transcriptome profile can be obtained from the reference slide (via the transcriptome profiler equipment 108 (FIG. 1), for example). Each one of the spots includes one or more cells.

At block 1255, the computing device can receive displaced spatial coordinates of spots within a second transcriptome profile of the biological tissue. The second transcriptome profile corresponds to the displaced image. Indeed, the second transcriptome profile can be obtained from the displaced slide (via the transcriptome profiler equipment 108 (FIG. 1), for example). As mentioned, each one of the spots includes one or more cells.

At block 1260, the computing device can perform, based on the coarse transformation, a first registration of the displaced spatial coordinates relative to the reference spatial coordinates, resulting in second displaced spatial coordinates of the spots within the second transcriptome profile. As part of the first registration, the computing device can apply the coarse transformation (e.g., an affine transformation) to the displaced spatial coordinates to move the spots to the second displaced spatial coordinates.

At block 1265, the computing device can perform, based on the registration transformation, a second registration of the second displaced spatial coordinates of the spots within the second transcriptome profile. As part of the second registration, the computing device can apply the registration transformation to the second displaced spatial coordinates to further move the spots within the second transcriptome profile to the terminal positions defined relative to the reference 2D coordinate system.

By implementing the example method 1200, the computing device can align the spots from the reference slide and the displaced slide. To that end, as is described above, the computing device relies on the coarse transformation and registration transformation determined by aligning the reference image and the displaced image in accordance with aspects described herein.

FIG. 13 is a flowchart of an example method 1300 for normalizing images of biological tissue, in accordance with one or more embodiments of this disclosure. Again, the images can be histological staining images, IHC images, or ISH images (such as FISH images). The computing device, or in some cases, the computing system, that implements the example method 1200 (FIG. 12) can implement the example method 1300.

At block 1310, the computing device can receive an image of biological tissue. The image can be a histological staining image. Such an image can be obtained using one of various types of histology staining techniques. Thus, the image can be an RGB colored image. In some cases, the image of biological tissue is a reference image of the biological tissue. In other cases, the image of biological tissue is a displaced image of the biological tissue.

At block 1320, the computing device can determine if color normalization is to be applied to the input image. To that end, the computing device can apply a color deviation criterion and/or a color inconsistency criterion to the input image. In response to a positive determination (“Yes” branch) the computing device can normalize color of the image at block 1330, and can then direct flow of the example method 1300 to block 1340. Normalizing color of the input image can include scaling each RGB color channel such that at each pixel of the image, the intensity value in each channel is in the interval [0,1]. In response to a negative determination (“No” branch), the computing device can direct flow of the example method to block 1340.

At block 1340, the computing device can generate a tissue mask image for the input image. The tissue mask image can be generated by separating tissue foreground pixels and the non-tissue background pixels as is described herein.

At block 1350, the computing device can configure the non-tissue background pixels as black pixels. The tissue mask image having black pixels constitutes a normalized input image. The example method 1300 can optionally include block 1360 where the computing device could apply one or multiple shaping operations to the normalized input image. As is described herein, the shaping operations can include cropping and resizing. The normalized input image can be cropped to remove undesired background sections, and can be resized so that the normalized input image has a size suitable for input into the ML alignment model referred to in the example method 1200.

FIG. 14 is a flowchart of an example method 1400 for normalizing images of biological tissue using transcriptome profiling data, in accordance with one or more embodiment of this disclosure. As is described herein, the images can be histological staining images, IHC images, or ISH images (such as FISH images). The computing device, or in some cases, the computing system, that implements the example method 1200 (FIG. 12) can implement the example method 1400.

At block 1410, the computing device can receive transcriptome profiling data corresponding to an image of biological tissue. The transcriptome profiling data can be obtained from a slide of the biological tissue that is used to obtain the image of that tissue.

At block 1420, the computing device can generate, based on the transcriptome profiling data, a label map including a first label associated with multiple first pixels and a second label associated with multiple second pixels.

At block 1430, the computing device can generate a contour map based on the label map. As is described herein, the contour map reflects transcriptome-derived spatial organization of the tissue spots (or cells, in single-cell resolved measurements). Accordingly, a first contour in the contour map defines a boundary that separates a subset of multiple first pixels having a first cluster label and a subset of the multiple second pixels having a second cluster label.

At block 1440, the computing device can identify, within a normalized version of the image, sets of particular pixels corresponding to respective contours in the contour map. Thus, the computing device can identify a first set of pixels corresponding to a first contour in the contour map, and also can identify a second set of pixels corresponding to a second contour in the contour map.

Based on the identified sets of particular pixels, the computing device can superimpose the contour map on the normalized version of the image at block 1450. To that end, the computing device can update the normalized version of the image by modifying respective values of pixels that constitute the sets of particular pixels. Each value of the respective values can arise from a linear combination of a first value from the normalized version of the image and a second value based on the transcriptome profiling data.

As mentioned, transforming transcriptome data into a contour map and incorporating the contour map into an image of biological issue can permit minimizing the impact of noise and batch effect on the alignment of a pair of images of biological tissue.

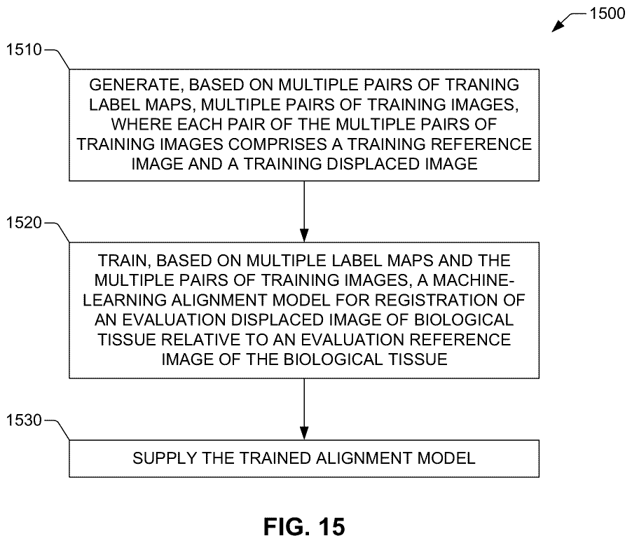

FIG. 15 is a flowchart of an example method 1500 for training an ML alignment model (also referred to as alignment model), in accordance with one or more embodiments of this disclosure. A computing device or a system of computing devices can implement the example method 1500 in its entirety or in part. To that end, each one of the computing devices includes computing resources that may implement at least one of the blocks included in the example method 1500. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, one or more of the computing devices may include programming interface(s); an operating system; software for configuration and/or control of a virtualized environment; firmware; and similar resources. The system of computing devices can be referred to as a computing system.

In some cases, the computing system that implements the example method 1500 can host the image generator module 610 (FIG. 6) and the training module 620 (FIG. 6), amongst other software components/modules. The computing system can implement the example method 1500 by executing one or multiple instances of one or a combination of the image generator module 610 and the training module 620, for example. Thus, in response to execution, the image generator module 610 and the training module 620, individually or in combination, can perform the operations corresponding to the blocks, individually or in combination, of the example method 1500.

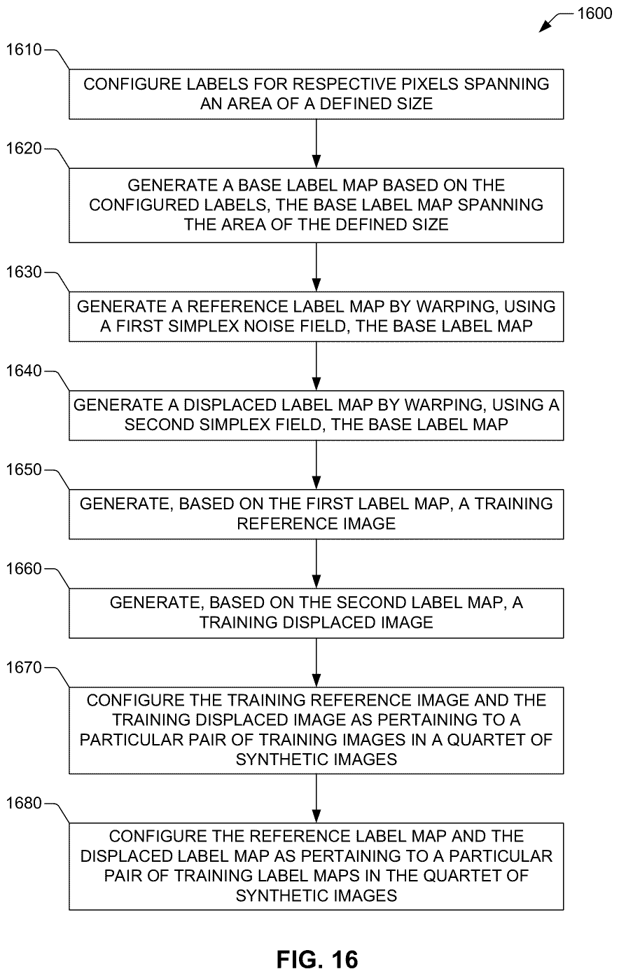

At block 1510, the computing system can generate, based on multiple pairs of training label maps, multiple pairs of training images. Each pair of the multiple pairs of training images includes a training reference image and a training displaced image. Each pair of the multiple pairs of training label maps comprises a training reference label map and a training displaced label map. The computing system can generate the multiple pairs of training images by implementing the example method 1600 shown in FIG. 16 and described hereinafter.

At block 1520, the computing system can train, based on the multiple pairs of label maps and the multiple pairs of training images, the ML alignment model for registration of an evaluation displaced image of biological tissue relative to an evaluation reference image of the biological tissue. The ML alignment model can yield a deformation vector field representative of a registration transformation between the evaluation reference image and the evaluation displaced image. The ML alignment model also can yield an inverse deformation vector field corresponding to the deformation vector field. Training the ML alignment model can include determining a solution to an optimization problem with respect to a loss function based on (i) a similarity metric of a pair of training label maps and (ii) a deformation vector field associated with a first training reference image and a first training displaced image in a pair of the multiple pairs of training images. Such a solution defines a trained machine-learning alignment model. In one example, the trained ML alignment model can be the alignment model 158 (FIG. 1).

The solution to the optimization problem can be determined iteratively. Thus, determining such a solution can iteratively continue until a termination criterion has been satisfied. Determining the solution to the optimization problem can include generating a current deformation field vector by applying a current alignment model to a first pair of training images. The current alignment model is configured at a current iteration of the determining the solution to the optimization problem. Additionally, determining the solution to the optimization problem can include applying the current deformation field vector to a displaced label map of a first pair of training label maps, resulting in a registered displaced label map. Further, determining the solution to the optimization problem can include determining, based on (i) a reference label map of the first pair of training label maps, (ii) the registered displaced label map, and (iii) the current deformation field vector, a value of the loss function (e.g., L(m, f) shown in Eq. (1)). Furthermore, determining the solution to the optimization problem can include generating, based on the value of the loss function, a next deformation field vector.

At block 1530, the computing system can supply the trained alignment model. The Supplying the trained alignment model can include storing that model within data storage (e.g., model storage 640 (FIG. 6) and, in some cases, configuring an interface (such as an API) to permit access to the stored trained alignment model via one or more function calls.

FIG. 16 is a flowchart of an example method 1600 for generating synthetic training data for training an ML alignment model, in accordance with one or more embodiments of this disclosure. The computing system, or in some cases, the computing device, that implements the example method 1500 (FIG. 15) can implement the example method 1600. As is described herein, the synthetic training data defines instances of training records comprising respective quartets of synthetic images. Each quartet consists of a pair of training label maps and a pair of training images. Generating the synthetic training data includes generating multiple such quartets.

At block 1610, the computing system can configure labels for respective pixels spanning an area of a defined size. The area can have a square shape having N pixels in one side and N pixels in another side. In some configurations, N=2^{q}, with q a natural number. For example, N can be equal to 256.

At block 1620, the computing system can generate a base label map based on the configured labels. The base label is a synthetic image that spans the area of the defined size. As is described herein, the base label map can be used to generate a first label map and a second label map. Specifically, at block 1630, the computing system can generate the reference label map by warping, using a first simplex noise field, the based label map. In addition, at block 1640, the computing system can generate a displaced label map by also warping, using a second simple noise field, the base label map. Although not shown, the computing system can configure the reference label map and the displaced label map as pertaining to a particular quartet of synthetic images.

At block 1650, the computing system can generate, based on the reference label map, a training reference image. In addition, at block 1660, the computing system can generate, based on the displaced label map, a training displaced image.

At block 1670, the computing system can configure the training reference image and the training displaced image as pertaining to a pair of training images within a particular quartet of synthetic images.

At block 1680, the computing system can configure the reference label map and the displaced label map as pertaining to a pair of training label maps within the particular quartet of synthetic images.

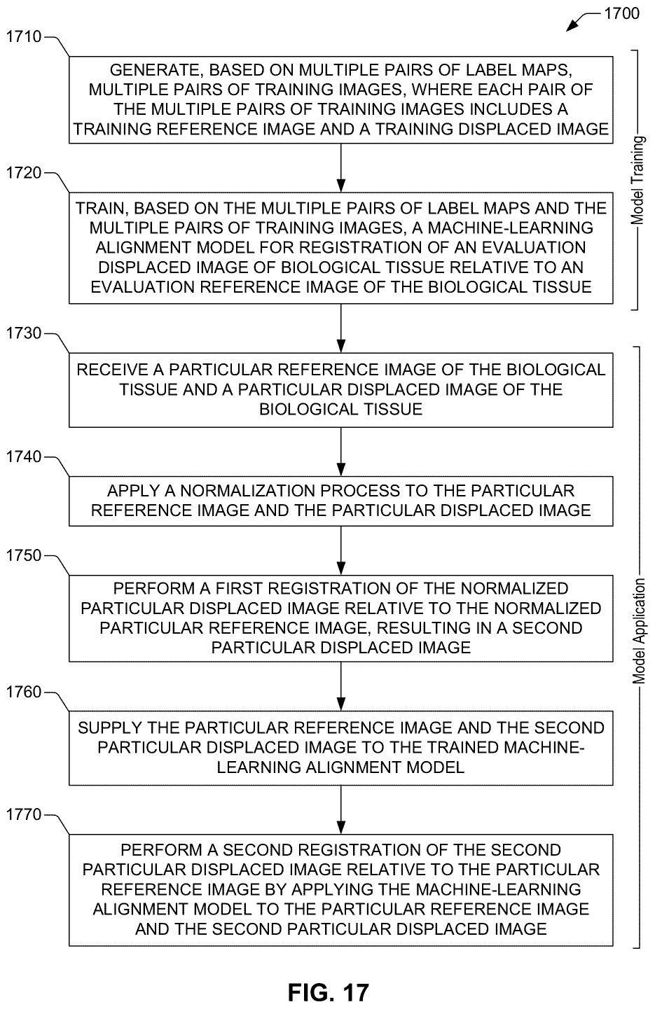

FIG. 17 illustrates an example method 1700 for obtaining an alignment model and aligning images of biological tissue to a common coordinate system, in accordance with one or more embodiments of this disclosure. As is described herein, the images can be histological staining images, IHC images, or ISH images (such as FISH images). A computing device or a system of computing devices can implement the example method 1700 in its entirety or in part. To that end, each one of the computing devices includes computing resources that may implement at least one of the blocks included in the example method 1700. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, one or more of the system of computing devices may include programming interface(s); an operating system; software for configuration and/or control of a virtualized environment; firmware; and similar resources. The system of computing devices can be referred to as a computing system.

In some cases, the computing system that implements the example method 1700 can host the image generator module 610 (FIG. 6), the training module 620 (FIG. 6), the ingestion module 130, the normalization module 140, the transformation module 150 (including the tessellation component 310, in some cases) and the alignment module 160, amongst other software components/modules. The computing system can implement the example method 1700 by executing one or multiple instances of one or a combination of the image generator module 610 (FIG. 6), the training module 620 (FIG. 6), the ingestion module 130, the normalization module 140, the transformation module 150 (including the tessellation component 310, in some cases) and the alignment module 160, for example. Thus, in response to execution, the image generator module 610 (FIG. 6), the training module 620 (FIG. 6), the ingestion module 130, the normalization module 140, the transformation module 150 (including the tessellation component 310, in some cases) and the alignment module 160, individually or in combination, can perform the operations corresponding to the blocks, individually or in combination, of the example method 1700.

At block 1710, the computing system can generate, based on multiple pairs of label maps, multiple pairs of training images. Each pair of the multiple pairs of training images includes a training reference image and a training displaced image. Each pair of the multiple pairs of training label maps comprises a training reference label map and a training displaced label map.

At block 1720, the computing system can train, based on the multiple pairs of label maps and the multiple pairs of training images, a ML alignment model for registration of an evaluation displaced image of biological tissue relative to an evaluation reference image of the biological tissue. The machine-learning alignment model can yield a deformation vector field representative of a registration transformation between the evaluation reference image and the evaluation displaced image. Training the ML alignment model can include determining a solution to an optimization problem with respect to a loss function based on a similarity metric of a pair of label maps and a deformation vector field associated with a first training reference image and a first training displaced image in a pair of the multiple pairs of training images. Such a solution defines a trained machine-learning alignment model.

At block 1730, the computing system can receive a particular reference image of the biological tissue and a particular displaced image of the biological tissue.

At block 1740, the computing system can apply a normalization process to the particular reference image and the particular displaced image. As is described herein, the normalization process can include various operations involving a tissue image and, optionally, transcriptome profiling data acquired on a same slide used to obtain the tissue image. To apply the normalization process to the reference image and the displaced image, the computing device can implement the example method 500 (FIG. 5) and, optionally, the example method 600 (FIG. 6) described hereinafter. When implementing those example methods, the reference image and the displaced image individually serve as input tissue image in respective applications of the normalization process.

At block 1750, the computing system can perform a first registration of the normalized particular displaced image relative to the normalized particular reference image. As is described herein, performing the first registration comprises determining an affine transformation between the normalized displaced image and the normalized reference image. Performing such a first registration results in a second displaced image.

At block 1760, the computing system can supply the particular reference image and the second particular displaced image to the trained ML alignment model.

At block 1770, the computing system can perform a second registration of the second particular displaced image relative to the particular reference image by applying the machine-learning alignment model to the particular reference image and the second particular displaced image.

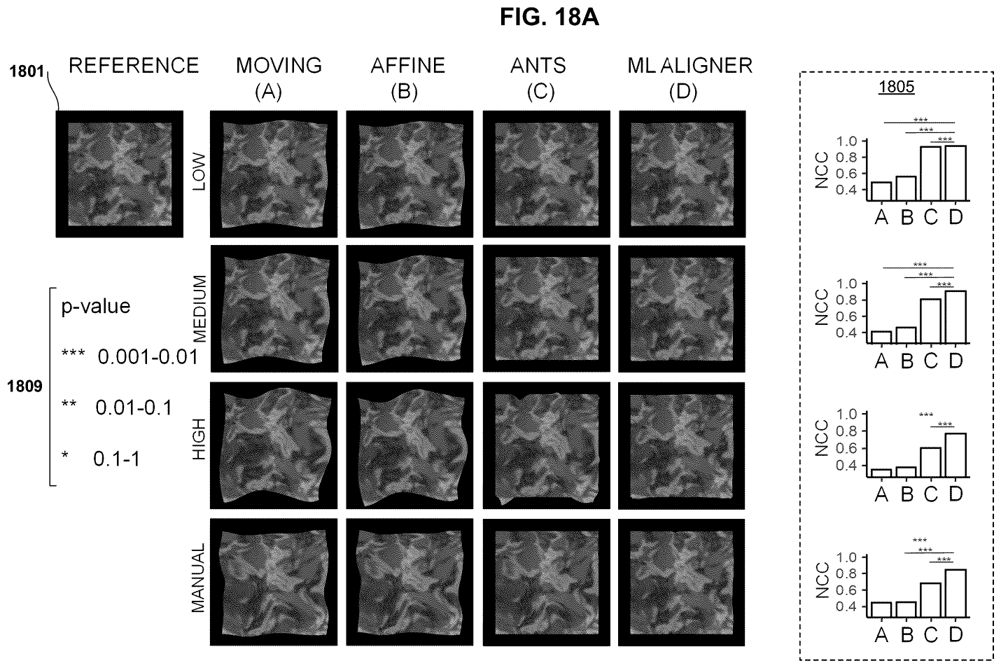

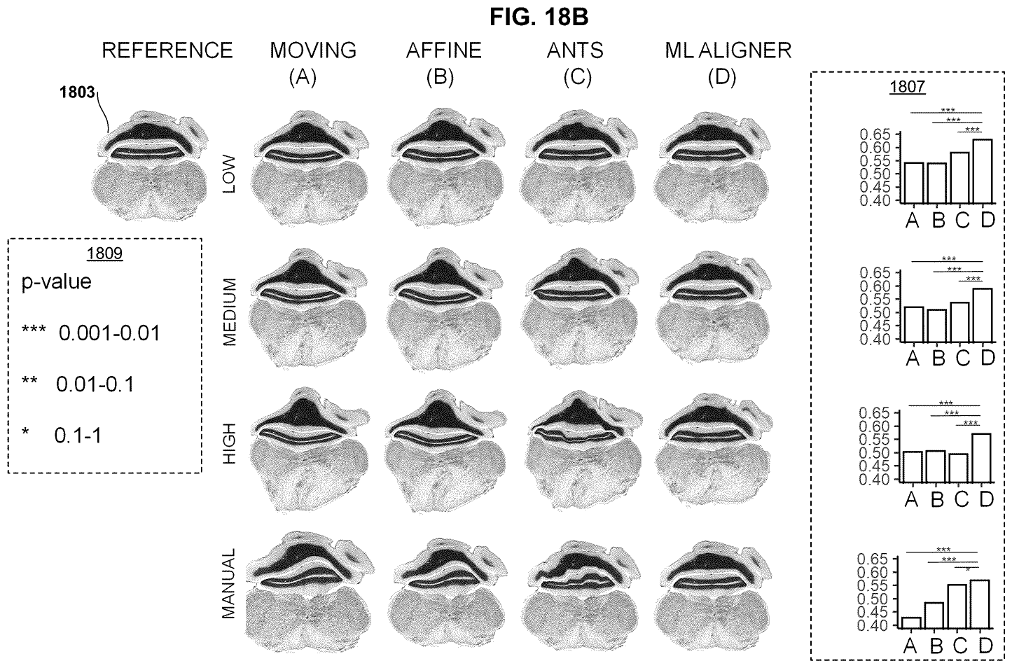

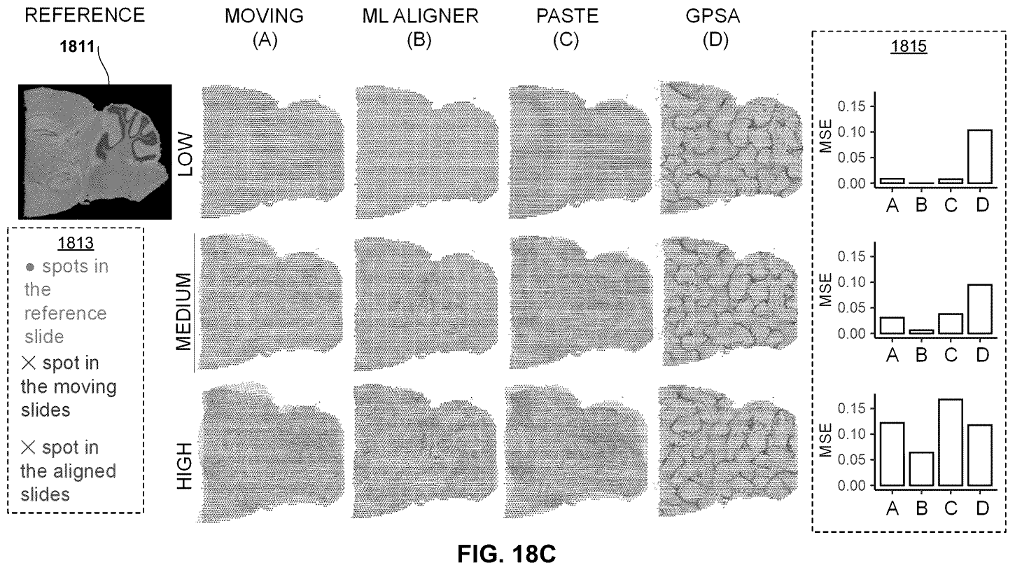

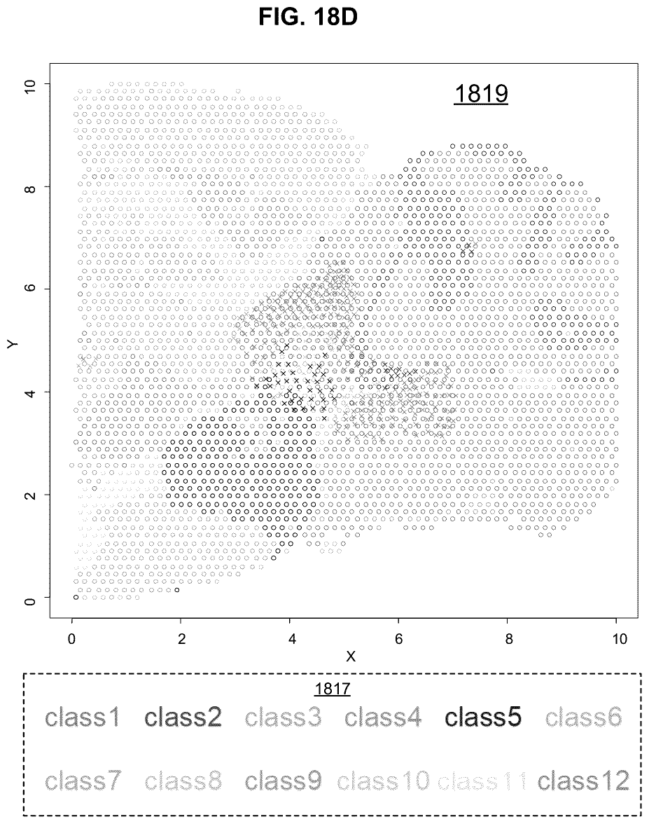

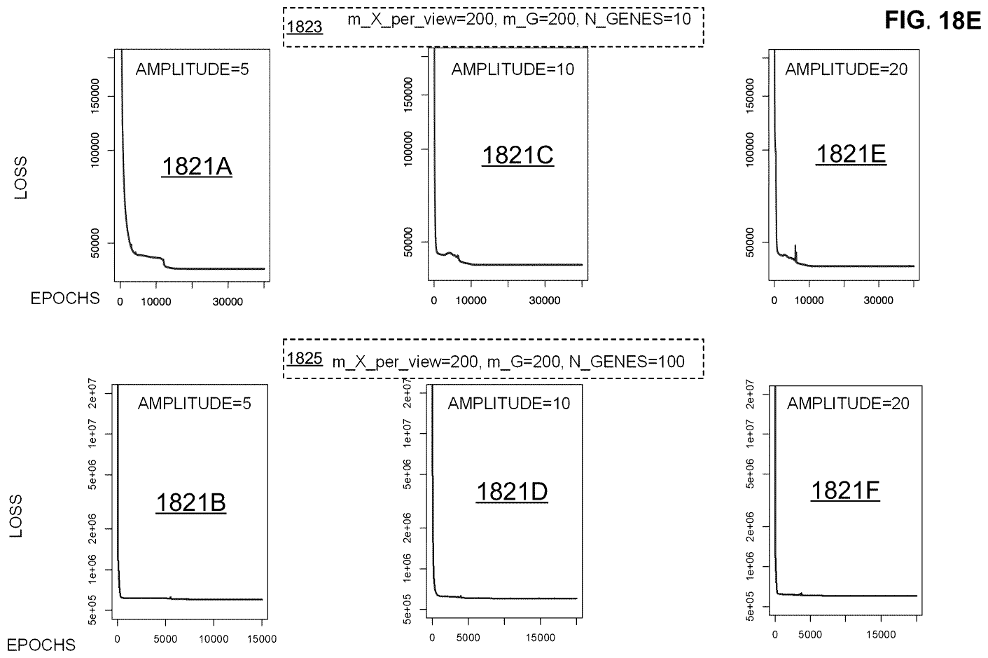

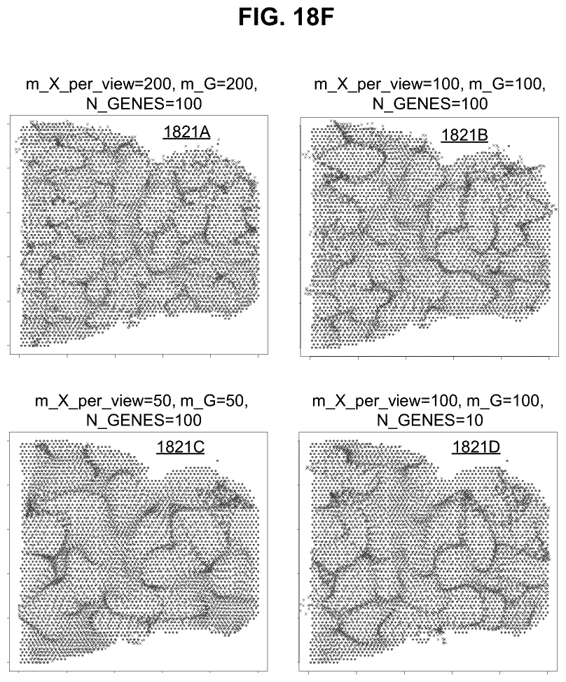

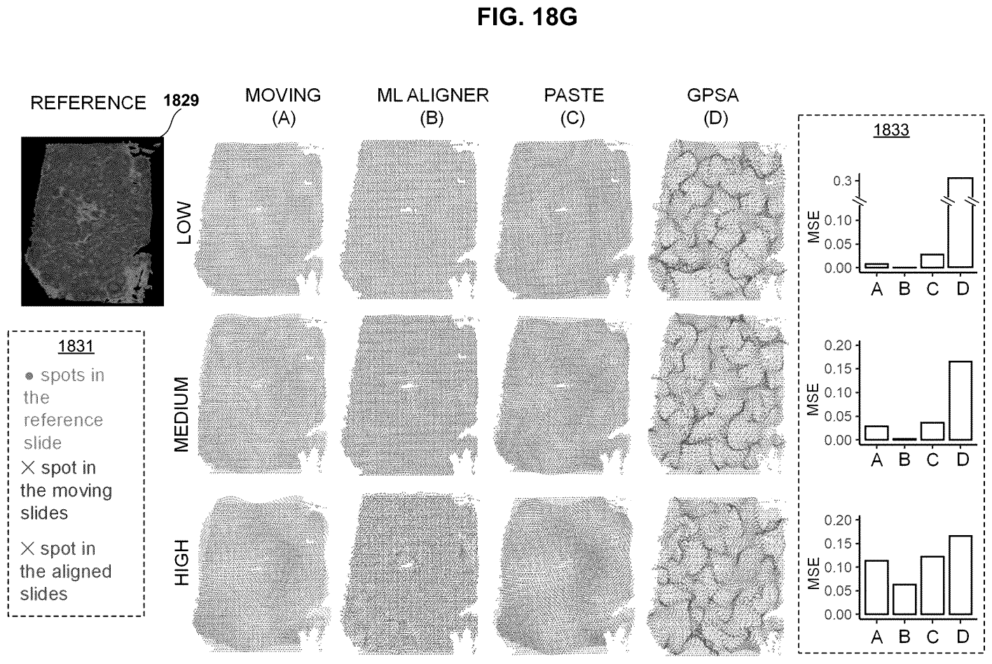

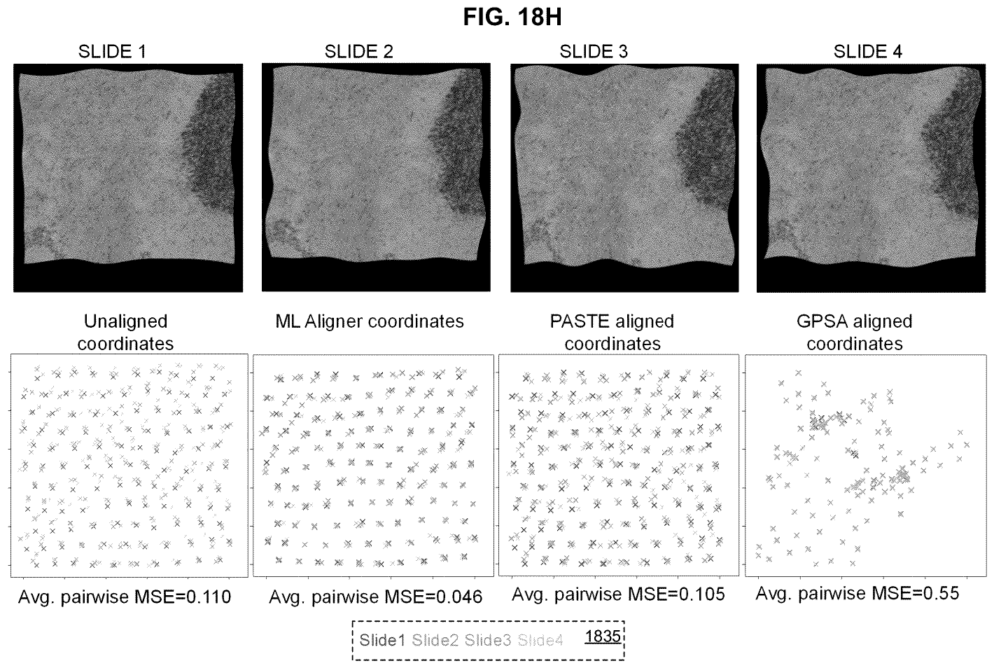

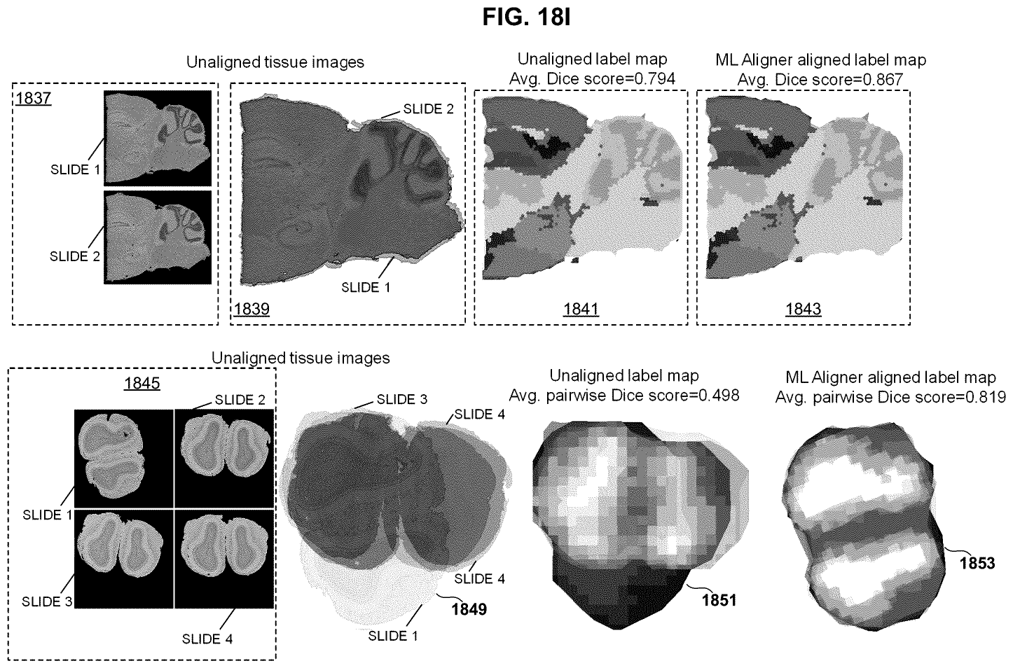

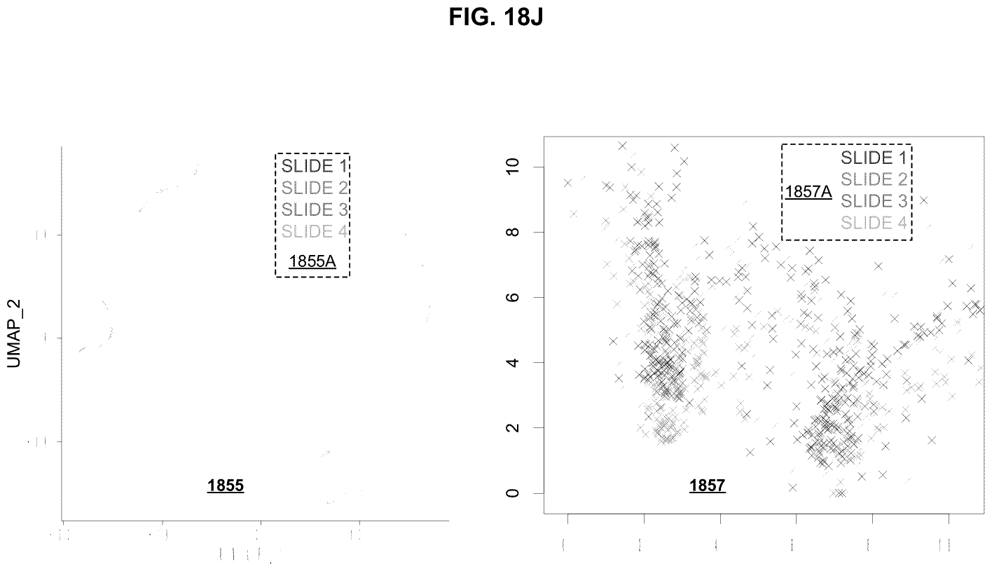

FIGS. 18A-18J illustrate further alignment performance and/or validation data associated with various scenarios having different slide types and arrangements of slides, in accordance with embodiments of this disclosure. In FIGS. 18A-18J, performance and/or validation statistics associated with the embodiments of this disclosure have been generically denoted as “ML Aligner” simply for the sake of nomenclature.

FIGS. 18A and 18B illustrate performance of the ML Aligner, trained with synthetic images as described herein, compared to performance of previously published methods, referred to herein and the Figures as “PASTE” and “GPSA.” A synthetic/reference image 1801 not used for the training or a real tissue histology image is shown in FIG. 18A. This image 1801 was generated by adding simplex noises of varying amplitudes. A reference image 1803 of a coronal slice/slide of a mouse hindbrain is shown in FIG. 18B. The image 1803 was generated using simplex noise wrapping and manual wrapping to create a set of moving images. As shown in the (A) column of FIGS. 18A and 18B, the images 1801,1803 were digitally distorted to a low, medium, or high level, or manually warped to generate a series of moving/displaced images. The original, un-warped images served as references (1801,1803). The degree of the distortions is quantified as the “moving” NCC score in the bar plots 1805 and 1807, illustrated in FIGS. 18A and 18B, respectively. The ML Aligner, together with an affine method (e.g., an affine transformation) and a non-linear alignment method offered by Advanced Normalization Tools (referred to herein as “ANTs”), were applied to align each of the moving/displaced images to the corresponding reference image 1801 or 1803. The aligned images from each method are shown in FIGS. 18A and 18B, together with their post-alignment NCC scores shown in the bar plots 1805,1807. The displayed NCC value of the ML Aligner and ANTs is the mean over 10 repeated runs. The associated error bars are also plotted yet are very small. The statistical significance of the increase in the ML Aligner's NCC values relative to other methods is marked by asterisks and explained in the annotations 1809 (FIG. 18A) and 1811 (FIG. 18B) on the left-hand side regarding p-value.

FIG. 18C illustrates an evaluation of the ML Aligner in aligning digitally-warped spatial transcriptome slices/slides/images of a mouse brain, shown in FIG. 18C as reference image 1811, compared to performance of the previously published methods, “PASTE” and “GPSA. Specifically, the reference image 1811 shows a mouse sagittal posterior brain slice/slide/image profiled by the 10×Genomics Visium platform (“Visium”). The reference image 1811 was digitally warped using Simplex noises to a low (noise amplitude=5, NCC of the deformed image=0.606), medium (noise amplitude=10, NCC of the deformed image=0.566), or high (noise amplitude=20, NCC of the deformed image=0.534) level to generate a series of moving slices/slides/images (noise frequency remains 1 for all warping) shown in the (A) column of FIG. 18C. As indicated in legend 1813, gray dots correspond to spots in the reference image 1811. The legend 1813 also indicates that blue crosses correspond to spots in the series of moving slices/slides/images in column (B) of FIG. 18C, while red cross correspond to spots in the aligned images in columns (B)-(D) of FIG. 18C. The discordance between the spatial coordinates of the spots in each moving slice/slide/image and those in the reference slice/slide/image was quantified by the Mean Squared Error (Methods) shown in bar plots 1815. The ML Aligner, together with previously published methods PASTE and GPSA, were applied to align each of the moving spatial transcriptome slices/slides/images to the reference image 1811. The coordinates of the spots before alignment (blue crosses, as indicated in the legend 1813) and after alignment (red crosses, as indicated in the legend 1813) are shown in FIG. 18C with the reference image's 1811 spot coordinates (gray dots, as indicated in the legend 1813) to aid the visual comparison. The post-alignment MSEs from each method are illustrated in the bar plots 1815. Values from the ML Aligner and GPSA are the average over 10 runs, shown with small error bars in the bar plots 1815.

FIG. 18D illustrates a graph 1819 showing spatial consistency of class labels 1817 of the tissue spots in the reference image 1811 and the ML Aligner-aligned slides from FIG. 18C. The presented data is taken from the highly distorted instance in FIG. 18C (Simplex noise amplitude=20, NCC of the deformed image=0.534). The spots in the reference image 1811 (shown in FIG. 18C as circles) and in the moved image (shown in FIG. 18C as crosses) share the same color code of the classes 1817. The displayed spots on the moved slide were aligned by the ML Aligner and have the top 10% largest MSEs relative to their reference counterparts. Most of the crosses illustrated in FIG. 18C are correctly located in the regions that contain the circles of the same color, indicating their spatial locations are valid regarding their class labels 1817.

FIG. 18E illustrates graphs 1821A-F showing trajectories of the loss of GPSA when aligning the moving slides shown in the (D) column of FIG. 18C with low distortion (1821A,1821B), medium distortion (1821C,1821D), and high distortion (1821E,1821F). The graphs 1821A and 1821B show trajectories of the loss of GPSA when aligning the moving slides shown in FIG. 18D with low distortion. The graphs 1821C and 1821D show trajectories of the loss of GPSA when aligning the moving slides shown in FIG. 18D with medium distortion. And the graphs 1821D and 1821E show trajectories of the loss of GPSA when aligning the moving slides shown in FIG. 18D with high distortion. With respect to the graphs 1821A, 1821C, and 1821E, GPSA was executed with parameters 1823 for the Visium platform (m_X_per_view=200, m_G=200, and N_GENES=10). According to the loss trajectory, GPSA was ran for 20,000 epochs or more until the convergence was achieved. The graphs 1821B, 1821D, and 1821F illustrate trajectories of the loss of GPSA when aligning the same moving slides (shown in FIG. 18D) used with parameters 1825 (N_GENES=100 while retaining m_X_per_view=200 and m_G=200).

FIG. 18F shows graphs 1827A-1827D. Each of the graphs shown in FIG. 18F are a comparison of GPSA-aligned spot coordinates (shown as red crosses) to the reference coordinates (shown as grey dots) when aligning the moving slides shown in the (D) column of FIG. 18C. For the graph 1821A, the parameter settings for the Visium platform were m_X_per_view=200, m_G=200, and N_GENES=100. For the graph 1821B, the parameter settings for the Visium platform were m_X_per_view=100, m_G=100, and N_GENES=100. For the graph 1821C, the parameter settings for the Visium platform were m_X_per_view=50, m_G=50, and N_GENES=100. For the graph 1821D, the parameter settings for the Visium platform were m_X_per_view=100, m_G=100, and N_GENES=10. In all cases, and as shown in FIG. 18F, the GPSA resulted in aggregated spatial coordinates.

FIG. 18G illustrates performance of the ML Aligner in aligning digitally-warped spatial transcriptome slices/slides/images of human lymph nodes, shown in FIG. 18G as reference image 1829, compared to performance of the previously published methods, “PASTE” and “GPSA. Specifically, the reference image 1829 is a human lymph node dissection profiled by the 10× Genomics Visium platform. The reference image 1829 was digitally warped using Simplex noises to a low (noise amplitude=5, NCC of the deformed image=0.621), medium (noise amplitude=10, NCC of the deformed image=0.540), or high (noise amplitude=20, NCC of the deformed image=0.504) level to generate a series of moving slices/slides/images (noise frequency remains 1 for all warping) shown in the (A) column of FIG. 18G. As indicated in legend 1831, gray dots correspond to spots in the reference image 1829. The legend 1831 also indicates that blue crosses correspond to spots in the series of moving slices/slides/images in column (B) of FIG. 18G, while red cross correspond to spots in the aligned images in columns (B)-(D) of FIG. 18G. The discordance between the spatial coordinates of the spots in each moving slice and those in the reference slices/slide/image was quantified by the MSE (Methods) shown in bar plots 1833. The ML Aligner, together with the previously published methods PASTE and GPSA, were applied to align each of the moving spatial transcriptome slices/slides/images in column (B) of FIG. 18G to the reference image 1829. The coordinates of the spots before alignment (blue crosses, as indicated in the legend 1831) and after alignment (red crosses, as indicated in the legend 1831) are shown in FIG. 18G together with the reference image's 1829 spot coordinates (gray dots, as indicated in the legend 1831) to aid the visual comparison. The post-alignment MSEs from each method are illustrated in the bar plots 1833. Values from the ML Aligner and GPSA are the average over 10 runs, shown with small error bars in the bar plots 1833.

FIG. 18H illustrates performance of the ML Aligner in a de novo alignment of spatial transcriptome slices/slides/images. The top row of FIG. 18H displays four moving spatial transcriptome slices/slides/images that were independently warped from the reference image 1811 taken from the mouse posterior brain noted above. The top row of FIG. 18H shows spot coordinates as crosses over the corresponding image (slide 1: red, slide 2: green, slide 3: blue, slide 4: orange, as indicated by legend 1835). With respect to FIG. 18H, the warping of the reference image 1811 was conducted using random-seeded Simplex noises with an amplitude of 15 and frequency of 1. The mean pair-wise NCCs among the tissue images of the moving slices/slides/images is 0.198. The average pair-wise MSE among the spot coordinates in the moving slices/slides/images is 0.10. The bottom row of FIG. 18H illustrates the spot coordinates from the four slices/slides/images shown in the top row before alignment (“Unaligned coordinates”) and after alignment by the ML Aligner, PASTE and GPSA, respectively, using the same colors and cross symbols as shown in the top row of FIG. 18H. The post-alignment average MSE over all pairs of slices is 0.046, 0.105 and 0.55 for the ML Aligner, PASTE and GPSA, respectively.

FIG. 18I illustrates results of application of the ML Aligner in real spatial transcriptome slices/slides/images. Two consecutive sagittal dissections of mouse brain (profiled by Visium) are shown in the top row of FIG. 18I at 1837 with two slices/slides/images labeled as “slide 1” and “slide 2,” respectively. Prior to alignment, differences between the slices/slides/images shown in 1837 are illustrated in superimposed tissue images at 1839. The lower/red portion of 1839 corresponds to slide 1 of 1837 and the upper/green portion of 1839 corresponds to slide 2 of 1837. The spatial consistency of tissue spot clusters between the slices/slides/images shown in 1837 were assessed before alignment (1841) after alignment (1843) in the form of superimposed class label maps. The slices/slides/images in 1837 contain identical classes, which are depicted in FIG. 18I with shades of yellow and blue in each of 1841 and 1843. Each superimposed map shown in 1841 and 1843 is generated by combining the colors from both slices/slides/images (1837) in each RGB channel with a mixing ratio of 0.5 each, and regions displaying various shades of grey in 1841 and 1843 indicate agreement between the class labels of the two slices/slides/images in 1837. The accompanying Dice score between the unaligned label maps (1841) is 0.794. After alignment by the ML Aligner, the Dice score increases to 0.867 (1843).

In the bottom row of FIG. 18I at 1845, four biological replicates of dissected mouse olfactory bulbs are shown as slides 1-4. To illustrate their spatial discordance, the bottom row of FIG. 18I at 1849 shows superimposed tissue slices/slides/images from 1845 with colors representing each slice/slide/image (grey for “slide 1,” red for “slide 2,” green for “slide 3,” and blue for “slide 4”). The classes in 1849 (a label map) are represented in varying shades of grey, red, green and blue, respectively. For the superimposition of label maps, the colors from all four slices/slides/images in 1847 are combined in each RGB channel with an equal mixing ratio of 0.25. Regions exhibiting different shades of grey signify agreement between the class labels across the four slices/slides/images in 1847. Prior to the ML Aligner's alignment, the Dice score is 0.498 (shown in 1851 of FIG. 18I). After the ML Aligner's alignment, the Dice score improves to 0.819 (shown in the 1853 of FIG. 18I).

FIG. 18J shows two graphs, 1855 and 1857, illustrating batch effect in a mouse olfactory bulb spatial transcriptome dataset. In the graph 1855 shown on the left side of FIG. 18J, tissue spots from the four mouse olfactory bulb slides (slides 1-4 shown at 1845 of FIG. 18I) noted above were clustered based on their gene expression profiles and visualized in a UMAP. Spots in the graph 1855 form four slide-specific clusters, indicating there exists a non-negligible batch effect across the slides. As indicated in legend 1855A of the graph 1855, the red cluster corresponds to slide 1 of 1845; the green cluster corresponds to slide 2 of 1845; the blue cluster corresponds to slide 3 of 1845; and the purple cluster corresponds to slide 4 of 1845. In the graph 1857 shown on the right of FIG. 18J, the tissue spot coordinates from the slides 1-4 shown at 1845 of FIG. 18I are shown after performance of a de novo alignment by GPSA. As indicated in legend 1857A of the graph 1855, the red crosses in 1857 correspond to slide 1 of 1845; the green crosses in 1857 correspond to slide 2 of 1845; the blue crosses in 1857 correspond to slide 3 of 1845; and the purple crosses in 1857 correspond to slide 4 of 1845. The graph 1857 shows a severe deviation of the coordinates from the expected square grid, which reveals the limitation of GPSA. In addition, among the aligned slides themselves, the mutual agreement in the spot coordinates is low (mean pair-wise MSE=24.09), suggesting GPSA is susceptible to the batch effect in the transcriptome data.

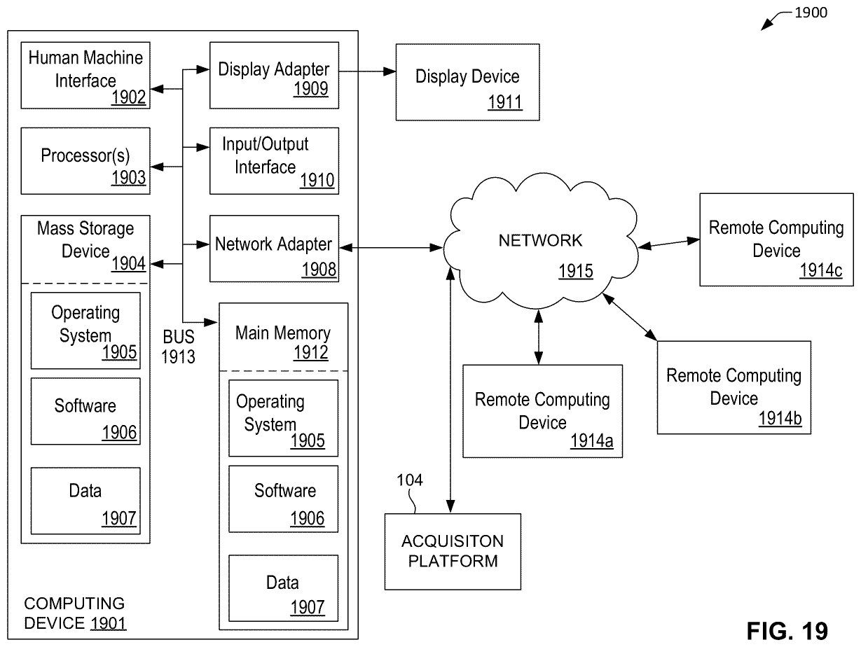

The methods and systems for image alignment in accordance with aspects described herein can be implemented on the computing system 1900 illustrated in FIG. 19 and described below. The computer-implemented methods, devices, and systems disclosed herein may utilize one or more computing devices to perform one or more functions in one or more locations. FIG. 19 is a block diagram depicting an example computing system 1900 for performing the disclosed methods and/or implementing the disclosed systems. The computing system 1900 is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment. The computing environment 1900 shown in FIG. 19 can embody, or can constitute, the computing system 100 (FIG. 1 or FIG. 3). The computing system 1900 may implement the various functionalities described herein in connection with alignment of images of biological tissue relative to a common coordinate system. For example, one or more of the computing devices that form the computing system 1900 can include the ingestion module 130, normalization module 140, transformation module 150 (including the tessellation component 310, in some cases), and alignment module 160. In addition, or in some embodiments, as is described herein, the one or more computing devices that form the computing system 2500 also can include the image generator module 610 and the training module 620.

The computer-implemented methods, devices, and systems in accordance with this disclosure may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing environments that comprise any of the above systems or devices, and the like.

The processing of the disclosed computer-implemented methods, devices, and systems may be performed by software components. The disclosed systems, devices, and computer-implemented methods may be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods may also be practiced in grid-based and distributed computing environments where tasks are performed by remote processing devices that are linked through a communications network. In a distributed computing environment, program modules may be located in both local and remote computer storage media including memory storage devices.

Further, the systems, devices, and computer-implemented methods disclosed herein may be implemented via a general-purpose computing device in the form of a computing device 1901. The components of the computing device 1901 may comprise one or more processors 1903, a main memory 1912, and a system bus 1913 that couples various system components including the one or more processors 1903 to the main memory 1912. The system may utilize parallel computing.

The system bus 1913 represents one or more of several possible types of bus structures, including a memory bus or memory controller, a peripheral bus, an accelerated graphics port, or local bus using any of a variety of bus architectures. The system bus 1913, and all buses specified in this description may also be implemented over a wired or wireless network connection and each of the subsystems, including the one or more processors 1903, a mass storage device 1904, an operating system 1905, software 1906, data 1907, a network adapter 1908, the system memory 1912, an Input/Output interface 1910, a display adapter 1909, a display device 1911, and a human-machine interface 1902, may be contained within one or more remote computing devices 1914a,b,c at physically separate locations, connected through buses of this form, in effect implementing a fully distributed system.

The computing device 1901 typically comprises a variety of computer-readable media. Exemplary readable media may be any available media that is accessible by the computing device 1901 and comprises, for example, both volatile and non-volatile media, removable and non-removable media. The main memory 1912 comprises computer readable media in the form of volatile memory, such as random access memory (RAM), and/or non-volatile memory, such as read only memory (ROM). The main memory 1912 typically contains data such as the data 1907 and/or program modules such as the operating system 1905 and the software 1906 that are immediately accessible to and/or are presently operated on by the one or more processors 1903. For example, the software 1906 may include the ingestion module 130, normalization module 140, transformation module 150 (including the tessellation component 310, in some cases), and alignment module 160. In addition, or other embodiments, the software 1906 can also include the image generator module 610 and the training module 620. The operating system 1905 may be embodied in one of Windows operating system, Unix, or Linux, for example.

In another aspect, the computing device 1901 may also comprise other removable/non-removable, volatile/non-volatile computer storage media. For example, FIG. 19 illustrates the mass storage device 1904 which may provide non-volatile storage of computer code, computer readable instructions, data structures, program modules, and other data for the computing device 1901. For example and not meant to be limiting, the mass storage device 1904 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1904, including by way of example, the operating system 1905 and the software 1906. Each of the operating system 1905 and the software 1906 (or some combination thereof) may comprise elements of the programming and the software 1906. The data 1907 may also be stored on the mass storage device 1904. The data 1907 may be stored in any of one or more databases known in the art. Examples of such databases comprise, DB2®, Microsoft® Access, Microsoft® SQL Server, Oracle®, mySQL, PostgreSQL, SQLite, and the like. The databases may be centralized or distributed across multiple systems. The mass storage device 1904 and the main memory 1912, individually or in combination, can embody or can include the memory 170. In addition, or in some embodiments, the mass storage device 1904 can embody, or can include, the image storage 630 and the model storage 640. Further, or in yet other embodiments, a combination of the mass storage devices 1904 that can be present in the remote computing devices 1914a,b,c can embody, or can include, the data storage 110.

In another aspect, the user may enter commands and information into the computing device 1901 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices may be connected to the one or more processors 1903 via the human-machine interface 1902 that is coupled to the system bus 1913, but may be connected by other interface and bus structures, such as a parallel port, game port, an IEEE 1394 Port (also known as a Firewire port), a serial port, or a universal serial bus (USB).

In yet another aspect, the display device 1911 may also be connected to the system bus 1913 via an interface, such as the display adapter 1909. It is contemplated that the computing device 1901 may have more than one display adapter 1909 and the computing device 1901 may have more than one display device 1911. For example, the display device 1911 may be a monitor, an LCD (Liquid Crystal Display), or a projector. In addition to the display device 1911, other output peripheral devices may comprise components such as speakers (not shown) and a printer (not shown) which may be connected to the computing device 1901 via the Input/Output Interface 1910. Any operation and/or result of the methods may be output in any form to an output device. Such output may be any form of visual representation, including, but not limited to, textual, graphical, animation, audio, tactile, and the like. The display device 1911 and computing device 1901 may be part of one device, or separate devices.

The computing device 1901 may operate in a networked environment using logical connections to one or more remote computing devices 1914a,b,c. For example, a remote computing device may be a personal computer, portable computer, smartphone, a server device, a router device, a network computer, a peer device or other common network node, and so on. Logical connections between the computing device 1901 and a remote computing device 1914a,b,c may be made via a network 1915, such as a LAN and/or a general WAN. Such network connections may be through the network adapter 1908. The network adapter 1908 may be implemented in both wired and wireless environments.

For purposes of illustration, application programs and other executable program components such as the operating system 1905 are illustrated herein as discrete blocks, although it is recognized that such programs and components reside at various times in different storage components of the computing device 1901, and are executed by the one or more processors 1903 of the computer. An implementation of the software 1906 may be stored on or transmitted across some form of computer-readable media. Any of the disclosed methods may be performed by computer readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

It is to be understood that the methods and systems described here are not limited to specific operations, processes, components, or structure described, or to the order or particular combination of such operations or components as described. It is also to be understood that the terminology used herein is for the purpose of describing example embodiments only and is not intended to be restrictive or limiting.

As used herein the singular forms “a,” “an,” and “the” include both singular and plural referents unless the context clearly dictates otherwise. Values expressed as approximations, by use of antecedents such as “about” or “approximately,” shall include reasonable variations from the referenced values. If such approximate values are included with ranges, not only are the endpoints considered approximations, the magnitude of the range shall also be considered an approximation. Lists are to be considered exemplary and not restricted or limited to the elements comprising the list or to the order in which the elements have been listed unless the context clearly dictates otherwise.

Throughout the specification and claims of this disclosure, the following words have the meaning that is set forth: “comprise” and variations of the word, such as “comprising” and “comprises,” mean including but not limited to, and are not intended to exclude, for example, other additives, components, integers, or operations. “Include” and variations of the word, such as “including” are not intended to mean something that is restricted or limited to what is indicated as being included, or to exclude what is not indicated. “May” means something that is permissive but not restrictive or limiting. “Optional” or “optionally” means something that may or may not be included without changing the result or what is being described. “Prefer” and variations of the word such as “preferred” or “preferably” mean something that is exemplary and more ideal, but not required. “Such as” means something that serves simply as an example.

Operations and components described herein as being used to perform the disclosed methods and construct the disclosed systems are illustrative unless the context clearly dictates otherwise. It is to be understood that when combinations, subsets, interactions, groups, etc. of these operations and components are disclosed, that while specific reference of each various individual and collective combinations and permutation of these may not be explicitly disclosed, each is specifically contemplated and described herein, for all methods and systems. This applies to all aspects of this application including, but not limited to, operations in disclosed methods and/or the components disclosed in the systems. Thus, if there are a variety of additional operations that may be performed or components that may be added, it is understood that each of these additional operations may be performed and components added with any specific embodiment or combination of embodiments of the disclosed systems and methods.

Embodiments of this disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof, whether internal, networked, or cloud-based.

Embodiments of this disclosure have been described with reference to diagrams, flowcharts, and other illustrations of computer-implemented methods, systems, apparatuses, and computer program products. Each block of the block diagrams and flowchart illustrations, and combinations of blocks in the block diagrams and flowchart illustrations, respectively, may be implemented by processor-accessible instructions. Such instructions may include, for example, computer program instructions (e.g., processor-readable and/or processor-executable instructions). The processor-accessible instructions may be built (e.g., linked and compiled) and retained in processor-executable form in one or multiple memory devices or one or many other processor-accessible non-transitory storage media. These computer program instructions (built or otherwise) may be loaded onto a general-purpose computer, special purpose computer, or other programmable data processing apparatus to produce a machine. The loaded computer program instructions may be accessed and executed by one or multiple processors or other types of processing circuitry. In response to execution, the loaded computer program instructions provide the functionality described in connection with flowchart blocks (individually or in a particular combination) or blocks in block diagrams (individually or in a particular combination). Thus, such instructions which execute on the computer or other programmable data processing apparatus create a means for implementing the functions specified in the flowchart blocks (individually or in a particular combination) or blocks in block diagrams (individually or in a particular combination).

These computer program instructions may also be stored in a computer-readable memory that may direct a computer or other programmable data processing apparatus to function in a particular manner, such that the instructions stored in the computer-readable memory produce an article of manufacture including processor-accessible instruction (e.g., processor-readable instructions and/or processor-executable instructions) to implement the function specified in the flowchart blocks (individually or in a particular combination) or blocks in block diagrams (individually or in a particular combination). The computer program instructions (built or otherwise) may also be loaded onto a computer or other programmable data processing apparatus to cause a series of operations to be performed on the computer or other programmable apparatus to produce a computer-implemented process. The series of operations may be performed in response to execution by one or more processor or other types of processing circuitry. Thus, such instructions that execute on the computer or other programmable apparatus provide operations for implementing the functions specified in the flowchart blocks (individually or in a particular combination) or blocks in block diagrams (individually or in a particular combination).

Accordingly, blocks of the block diagrams and flowchart diagrams support combinations of means for performing the specified functions in connection with such diagrams and/or flowchart illustrations, combinations of operations for performing the specified functions and program instruction means for performing the specified functions. Each block of the block diagrams and flowchart illustrations, and combinations of blocks in the block diagrams and flowchart illustrations, may be implemented by special purpose hardware-based computer systems that perform the specified functions or operations, or combinations of special purpose hardware and computer instructions.

The methods and systems may employ artificial intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the computer-implemented methods, apparatuses, devices, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that an order be inferred, in any respect. This holds for any possible non-express basis for interpretation, including: matters of logic with respect to arrangement of operations or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

### Example Embodiments

Embodiment 1. A computer-implemented method, comprising: receiving a reference image of biological tissue; receiving a displaced image of the biological tissue; applying a normalization process to the reference image, resulting in a normalized reference image; applying the normalization process to the displaced image, resulting in a normalized displaced image; performing a first registration of the normalized displaced image relative to the normalized reference image, resulting in a group of parameters defining a coarse transformation and further resulting in a second displaced image; supplying the normalized reference image to a machine-learning alignment model; supplying the second displaced image to the machine-learning alignment model; and performing a second registration of the second displaced image relative to the reference image by applying the machine-learning alignment model to the reference image and the second displaced image, wherein the applying yields a deformation vector field representative of a registration transformation between the reference image and the second displaced image.

Embodiment 2. The computer-implemented method of embodiment 1, further comprising, receiving reference spatial coordinates of spots within a first transcriptome profile of the biological tissue, the first transcriptome profile corresponding to the reference image, wherein each spot comprises one or more cells; receiving displaced spatial coordinates of spots within a second transcriptome profile of the biological tissue, the second transcriptome profile corresponding to the displaced image; performing, based on the coarse transformation, a first registration of the displaced spatial coordinates relative to the reference spatial coordinates, resulting in second displaced spatial coordinates of the spots within the second transcriptome profile; and performing, based on the registration transformation, a second registration of the second displaced spatial coordinates of the spots within the second transcriptome profile.

Embodiment 3. The computer-implemented method of any one of embodiments 1 or 2, wherein the supplying the normalized reference image comprises: generating a tiling of the normalized reference image, wherein the tiling of the normalized reference image consists of a first defined number of tile images; and supplying, in sequence, each tile image of the tiling of the normalized reference image to the machine-learning alignment model.

Embodiment 4. The computer-implemented method of embodiment 3, wherein the supplying the second displaced image comprises: generating a tiling of the second displaced image, wherein the tiling of the second displaced image consists of a second defined number of tile images, the second defined number being equal to the first defined number; and supplying, in sequence, each tile image of the tiling of the second displaced image to the machine-learning alignment model, wherein a first tile image of the tiling of the second displaced image is supplied concurrently with a first tile image of the tiling of the normalized reference image; wherein the first tile image of the tiling of the second displaced image spans a section of the second displaced image, and wherein the first tile image of the tiling of the normalized reference image spans a section of the tiling of the normalized reference image, and wherein the section of the second displaced image and the section of the normalized reference image are identical to one another in terms of placement and size.

Embodiment 5. The computer-implemented method of embodiment 4, wherein the applying the machine-learning alignment model comprises applying the machine-learning alignment model to the first tile image of the tiling of the normalized reference image and the first tile image of the tiling of the second displaced image.

Embodiment 6. The computer-implemented method of embodiment 5, wherein the applying the machine-learning alignment model yields a first tile deformation vector field and a second tile deformation vector field, the method further comprising joining the first tile deformation vector field and the tile second deformation vector field to form, at least partially, the deformation vector field.

Embodiment 7. The computer-implemented method of embodiment 6, wherein each one of the first tile deformation vector field and the second tile deformation vector field and respective adjacent tile deformation vector fields have a defined region in common, the joining comprising, determining, for each pixel within the defined region in common, a weighted average of one of the first tile deformation vector field or the second tile deformation vector field and one of the respective adjacent tile deformation vector fields overlapping at the pixel; and assigning, for each pixel within the defined region in common, the weighted average to the deformation vector field.

Embodiment 8. The computer-implemented method of any one of the preceding embodiments, wherein the coarse transformation is an affine transformation, and wherein the performing the first registration comprises determining the affine transformation between the normalized displaced image and the normalized reference image.

Embodiment 9. The computer-implemented method of any one of the preceding embodiments, wherein the normalization process comprises: receiving an input image of the biological tissue; generating a tissue mask image for the input image; and configuring non-tissue pixels in the tissue mask image as black pixels; wherein the tissue mask image having black pixels constitutes a normalized input image.

Embodiment 10. The computer-implemented method of any one of the preceding embodiments, wherein the normalization process further comprises: receiving transcriptome profiling data corresponding to the input image; generating, based on the transcriptome profiling data, a label map comprising a first label associated with multiple first pixels and a second label associated with multiple second pixels; generating a contour map based on the label map, wherein a first contour in the contour map defines a boundary separating a subset of the multiple first pixels and a subset of the multiple second pixels; identifying, within the normalized input image, particular pixels corresponding to the first contour; updating the normalized input image by modifying respective values of the particular pixels, each value of the respective values arising from a linear combination of a first value from the normalized input image and a second value based on the transcriptome profiling data.

Embodiment 11. The computer-implemented method of any one of the preceding embodiments, wherein the machine-learning alignment model comprises a convolutional neural network (CNN) having an encoder module, a decoder module, and a field composition module configured to output the deformation vector field.

Embodiment 12. The computer-implemented method of any one of the preceding embodiments, wherein the machine-learning alignment model comprises a neural network comprising, one or more first layers configured to extract features from the normalized reference image and the second displaced image, the one or more first layers being of a first type; and one or more second layers configured to output the deformation vector field, the one or more second layers being of a second type.

Embodiment 13. A computer-implemented method, comprising: generating, based on multiple pairs of training label maps, multiple pairs of training images, wherein each pair of the multiple pairs of training images comprises a training reference image and a training displaced image; determining a solution to an optimization problem with respect to a loss function based on a similarity metric of a pair of training label maps and a deformation vector field representative of a registration transformation between a first training reference image and a first training displaced image in a pair of the multiple pairs of training images, wherein the solution defines an alignment model for registration of an evaluation displaced image of biological tissue relative to an evaluation reference image of the biological tissue.

Embodiment 14. The computer-implemented method of embodiment 12, wherein the determining the solution to the optimization problem comprises: generating a current deformation field vector by applying a current alignment model to a first pair of training images, wherein the current alignment model is configured at a current iteration of the determining the solution to the optimization problem; applying the current deformation field vector to a displaced label map of a first pair of training label maps, resulting in a registered displaced label map; determining, based on (i) a reference label map of the first pair of training label maps, (ii) the registered displaced label map, and (iii) the current deformation field vector, a value of the loss function; and generating, based on the value of the loss function, a next deformation field vector.

Embodiment 15. The computer-implemented method of embodiment 13, wherein the loss function comprises a Dice similarity coefficient and the gradient of the deformation vector field, wherein the gradient is weighted by a regularization factor.

Embodiment 16. The computer-implemented method of any one of embodiments 13-15, wherein the alignment model comprises a convolutional neural network (CNN) comprising an encoder module, a decoder module, and a field composition module configured to output the deformation vector field.

Embodiment 17. The computer-implemented method of any one of embodiments 13-16, wherein the machine-learning alignment model comprises a neural network comprising, one or more first layers configured to extract features from the normalized reference image and the second displaced image, the one or more first layers being of a first type; and one or more second layers configured to output the deformation vector field, the one or more second layers being of a second type.

Embodiment 18. The computer-implemented method of any one of embodiments 13-17, wherein the generating the multiple pairs of training images comprises: configuring labels for respective pixels spanning an area of a defined size; and generating a base label map based on the configured labels, the base label map spanning the area of the defined size.

Embodiment 19. The computer-implemented method of embodiment 18, wherein the configuring comprises: configuring multiple sets of simplex noise distributions within respective layers, each one of the layers corresponding to the area of the defined size, wherein a first set of the multiple sets comprises a first simplex noise distribution centered at respective positions within a first layer of the respective layers, and wherein a second set of the multiple sets comprises a second simplex noise distribution centered at respective positions within the second layer; configuring multiple defined labels for each pixel within the area, each one of the multiple defined labels corresponds to a particular layer of the respective layers; determining, using the multiple sets of simplex noise distributions, respective numerical weights for the multiple defined labels at a particular pixel within the area; and assigning, to the particular pixel, a first label corresponding to a first numerical weight having the greatest magnitude among the respective numerical weights.

Embodiment 20. The computer-implemented method of embodiment 19, wherein the generating the base label map comprises merging the respective layers having labeled pixels into a single defined layer defining the base label map.

Embodiment 21. The computer-implemented method of embodiment 18, wherein the generating the multiple pairs of training images further comprises: generating a reference label map by warping, using a first simplex noise field, the base label map; generating, based on the reference label map, a particular training reference image by, configuring, at random, colors for respective labels in the reference label map, resulting in a colored image; blurring the colored image, resulting in a blurred image; and applying a bias field to the blurred image, the bias intensity field spanning the area of the defined size.

Embodiment 22. The computer-implemented method of embodiment 21, wherein the generating the multiple pairs of training images further comprises: generating a displaced label map by warping, using a second simplex noise field, the base label map; generating, based on the displaced label map, a particular training displaced image by, configuring, at random, colors for respective labels in the second label map, resulting in a second colored image; blurring the second colored image, resulting in a second blurred image; and applying the bias intensity field to the second blurred image.

Embodiment 23. The computer-implemented method of embodiment 22, wherein the generating the multiple pairs of training images further comprises configuring the particular training reference image and the particular training displaced image as pertaining to a particular pair of the multiple pairs of images.

Embodiment 24. The computer-implemented method of embodiment 23, further comprising configuring the reference label map and the displaced label map as pertaining to a particular pair of multiple pairs of training label maps.

Embodiment 25. A computer-implemented method, comprising: generating, based on multiple pairs of training label maps, multiple pairs of training images, wherein each pair of the multiple pairs of training images comprises a training reference image and a training displaced image; training, based on multiple pairs of label maps and the multiple pairs of training images, a machine-learning alignment model for registration of an evaluation displaced image of biological tissue relative to an evaluation reference image of the biological tissue, wherein the alignment model yields a deformation vector field representative of a registration transformation between the evaluation reference image and the evaluation displaced image; receiving a particular reference image of the biological tissue and a particular displaced image of the biological tissue; applying a normalization process to the particular reference image and the particular displaced image; performing coarse registration of the normalized particular displaced image relative to the normalized particular reference image, resulting in a group of parameters defining a coarse transformation and further resulting in a second particular displaced image; supplying the particular reference image and the second particular displaced image to the trained machine-learning alignment model; performing fine registration of the second particular displaced image relative to the particular reference image by applying the machine-learning alignment model to the particular reference image and the second particular displaced image.

Embodiment 26. The computer-implemented method of embodiment 25, further comprising, receiving particular reference spatial coordinates of spots within a first transcriptome profile of the biological tissue, the first transcriptome profile corresponding to the reference image, wherein each spot comprises one or more cells; receiving particular displaced spatial coordinates of spots within a second transcriptome profile of the biological tissue, the second transcriptome profile corresponding to the displacement image; performing, based on the coarse transformation, coarse registration of the particular displaced spatial coordinates relative to the particular reference spatial coordinates, resulting in second particular displaced spatial coordinates of the spots within the second transcriptome profile; and performing, based on the registration transformation, fine registration of the second particular displaced spatial coordinates of the spots within the second transcriptome profile.

Embodiment 27. The computer-implemented method of any one of embodiments 25 or 26, wherein the training comprises determining a solution to an optimization problem with respect to a loss function based on a similarity metric of a first pair of training label maps of multiple pairs of training label maps and a deformation vector field associated with a first training reference image and a first training displaced image in a pair of the multiple pairs of training images, wherein the solution defines the trained machine-learning alignment model.

What is claimed is:

1. A computer-implemented method, comprising:
receiving a reference image of biological tissue;
receiving a displaced image of the biological tissue;
applying a normalization process to the reference image, resulting in a normalized reference image;
applying the normalization process to the displaced image, resulting in a normalized displaced image;
performing a first registration of the normalized displaced image relative to the normalized reference image, resulting in a group of parameters defining a coarse transformation and further resulting in a second displaced image;
supplying the normalized reference image to a machine-learning alignment model;
supplying the second displaced image to the machine-learning alignment model;
performing a second registration of the second displaced image relative to the reference image by applying the machine-learning alignment model to the reference image and the second displaced image, wherein the applying yields a deformation vector field representative of a registration transformation between the reference image and the second displaced image.

2. The computer-implemented method of claim 1, further comprising,
receiving reference spatial coordinates of spots within a first transcriptome profile of the biological tissue, the first transcriptome profile corresponding to the reference image, wherein each spot comprises one or more cells;
receiving displaced spatial coordinates of spots within a second transcriptome profile of the biological tissue, the second transcriptome profile corresponding to the displaced image;
performing, based on the coarse transformation, a first registration of the displaced spatial coordinates relative to the reference spatial coordinates, resulting in second displaced spatial coordinates of the spots within the second transcriptome profile; and
performing, based on the registration transformation, a second registration of the second displaced spatial coordinates of the spots within the second transcriptome profile.

3. The computer-implemented method of claim 1, wherein the supplying the normalized reference image comprises:
generating a tiling of the normalized reference image, wherein the tiling of the normalized reference image consists of a first defined number of tile images; and
supplying, in sequence, each tile image of the tiling of the normalized reference image to the machine-learning alignment model.

4. The computer-implemented method of claim 3, wherein the supplying the second displaced image comprises:
generating a tiling of the second displaced image, wherein the tiling of the second displaced image consists of a second defined number of tile images, the second defined number being equal to the first defined number; and
supplying, in sequence, each tile image of the tiling of the second displaced image to the machine-learning alignment model, wherein a first tile image of the tiling of the second displaced image is supplied concurrently with a first tile image of the tiling of the normalized reference image;
wherein the first tile image of the tiling of the second displaced image spans a section of the second displaced image, and wherein the first tile image of the tiling of the normalized reference image spans a section of the tiling of the normalized reference image, and
wherein the section of the second displaced image and the section of the normalized reference image are identical to one another in terms of placement and size.

5. The computer-implemented method of claim 4, wherein the applying the machine-learning alignment model comprises applying the machine-learning alignment model to the first tile image of the tiling of the normalized reference image and the first tile image of the tiling of the second displaced image.

6. The computer-implemented method of claim 5, wherein the applying the machine-learning alignment model yields a first tile deformation vector field and a second tile deformation vector field, the method further comprising joining the first tile deformation vector field and the tile second deformation vector field to form, at least partially, the deformation vector field.

7. The computer-implemented method of claim 6, wherein each one of the first tile deformation vector field and the second tile deformation vector field and respective adjacent tile deformation vector fields have a defined region in common, the joining comprising,
determining, for each pixel within the defined region in common, a weighted average of one of the first tile deformation vector field or the second tile deformation vector field and one of the respective adjacent tile deformation vector fields overlapping at the pixel; and
assigning, for each pixel within the defined region in common, the weighted average to the deformation vector field.

8. The computer-implemented method of claim 1, wherein the coarse transformation is an affine transformation, and wherein the performing the first registration comprises determining the affine transformation between the normalized displaced image and the normalized reference image.

9. The computer-implemented method of claim 1, wherein the normalization process comprises:
receiving an input image of the biological tissue;
generating a tissue mask image for the input image; and
configuring non-tissue pixels in the tissue mask image as black pixels;
wherein the tissue mask image having black pixels constitutes a normalized input image.

10. The computer-implemented method of claim 1, wherein the normalization process further comprises:
receiving transcriptome profiling data corresponding to the input image;
generating, based on the transcriptome profiling data, a label map comprising a first label associated with multiple first pixels and a second label associated with multiple second pixels;
generating a contour map based on the label map, wherein a first contour in the contour map defines a boundary separating a subset of the multiple first pixels and a subset of the multiple second pixels;
identifying, within the normalized input image, particular pixels corresponding to the first contour;
updating the normalized input image by modifying respective values of the particular pixels, each value of the respective values arising from a linear combination of a first value from the normalized input image and a second value based on the transcriptome profiling data.

11. The computer-implemented method of claim 1, wherein the machine-learning alignment model comprises a convolutional neural network (CNN) having an encoder module, a decoder module, and a field composition module configured to output the deformation vector field.

12. The computer-implemented method of claim 1, wherein the machine-learning alignment model comprises a neural network comprising,
one or more first layers configured to extract features from the normalized reference image and the second displaced image, the one or more first layers being of a first type; and
one or more second layers configured to output the deformation vector field, the one or more second layers being of a second type.

13. A computer-implemented method, comprising:
generating, based on multiple pairs of training label maps, multiple pairs of training images, wherein each pair of the multiple pairs of training images comprises a training reference image and a training displaced image;
determining a solution to an optimization problem with respect to a loss function based on a similarity metric of a pair of training label maps and a deformation vector field representative of a registration transformation between a first training reference image and a first training displaced image in a pair of the multiple pairs of training images,
wherein the solution defines an alignment model for registration of an evaluation displaced image of biological tissue relative to an evaluation reference image of the biological tissue.

14. The computer-implemented method of claim 12, wherein the determining the solution to the optimization problem comprises:
generating a current deformation field vector by applying a current alignment model to a first pair of training images, wherein the current alignment model is configured at a current iteration of the determining the solution to the optimization problem;
applying the current deformation field vector to a displaced label map of a first pair of training label maps, resulting in a registered displaced label map;
determining, based on (i) a reference label map of the first pair of training label maps, (ii) the registered displaced label map, and (iii) the current deformation field vector, a value of the loss function; and
generating, based on the value of the loss function, a next deformation field vector.

15. The computer-implemented method of claim 13, wherein the loss function comprises a Dice similarity coefficient and the gradient of the deformation vector field, wherein the gradient is weighted by a regularization factor.

16. The computer-implemented method of claim 13, wherein the alignment model comprises a convolutional neural network (CNN) comprising an encoder module, a decoder module, and a field composition module configured to output the deformation vector field.

17. The computer-implemented method of claim 13, wherein the machine-learning alignment model comprises a neural network comprising,
one or more first layers configured to extract features from the normalized reference image and the second displaced image, the one or more first layers being of a first type; and
one or more second layers configured to output the deformation vector field, the one or more second layers being of a second type.

18. The computer-implemented method of claim 13, wherein the generating the multiple pairs of training images comprises:
configuring labels for respective pixels spanning an area of a defined size; and
generating a base label map based on the configured labels, the base label map spanning the area of the defined size.

19. The computer-implemented method of claim 18, wherein the configuring comprises:
configuring multiple sets of simplex noise distributions within respective layers, each one of the layers corresponding to the area of the defined size, wherein a first set of the multiple sets comprises a first simplex noise distribution centered at respective positions within a first layer of the respective layers, and wherein a second set of the multiple sets comprises a second simplex noise distribution centered at respective positions within the second layer;
configuring multiple defined labels for each pixel within the area, each one of the multiple defined labels corresponds to a particular layer of the respective layers;
determining, using the multiple sets of simplex noise distributions, respective numerical weights for the multiple defined labels at a particular pixel within the area; and
assigning, to the particular pixel, a first label corresponding to a first numerical weight having the greatest magnitude among the respective numerical weights.

20. The computer-implemented method of claim 19, wherein the generating the base label map comprises merging the respective layers having labeled pixels into a single defined layer defining the base label map.

21. The computer-implemented method of claim 18, wherein the generating the multiple pairs of training images further comprises:
generating a reference label map by warping, using a first simplex noise field, the base label map;
generating, based on the reference label map, a particular training reference image by,
configuring, at random, colors for respective labels in the reference label map, resulting in a colored image;
blurring the colored image, resulting in a blurred image; and
applying a bias field to the blurred image, the bias intensity field spanning the area of the defined size.

22. The computer-implemented method of claim 21, wherein the generating the multiple pairs of training images further comprises:
generating a displaced label map by warping, using a second simplex noise field, the base label map;
generating, based on the displaced label map, a particular training displaced image by,
configuring, at random, colors for respective labels in the second label map, resulting in a second colored image;
blurring the second colored image, resulting in a second blurred image; and
applying the bias intensity field to the second blurred image.

23. The computer-implemented method of claim 22, wherein the generating the multiple pairs of training images further comprises configuring the particular training reference image and the particular training displaced image as pertaining to a particular pair of the multiple pairs of images.

24. The computer-implemented method of claim 23, further comprising configuring the reference label map and the displaced label map as pertaining to a particular pair of multiple pairs of training label maps.

25. A computer-implemented method, comprising:
generating, based on multiple pairs of training label maps, multiple pairs of training images, wherein each pair of the multiple pairs of training images comprises a training reference image and a training displaced image;
training, based on multiple pairs of label maps and the multiple pairs of training images, a machine-learning alignment model for registration of an evaluation displaced image of biological tissue relative to an evaluation reference image of the biological tissue, wherein the alignment model yields a deformation vector field representative of a registration transformation between the evaluation reference image and the evaluation displaced image;
receiving a particular reference image of the biological tissue and a particular displaced image of the biological tissue;
applying a normalization process to the particular reference image and the particular displaced image;
performing coarse registration of the normalized particular displaced image relative to the normalized particular reference image, resulting in a group of parameters defining a coarse transformation and further resulting in a second particular displaced image;
supplying the particular reference image and the second particular displaced image to the trained machine-learning alignment model;
performing fine registration of the second particular displaced image relative to the particular reference image by applying the machine-learning alignment model to the particular reference image and the second particular displaced image.

26. The computer-implemented method of claim 25, further comprising,
receiving particular reference spatial coordinates of spots within a first transcriptome profile of the biological tissue, the first transcriptome profile corresponding to the reference image, wherein each spot comprises one or more cells;
receiving particular displaced spatial coordinates of spots within a second transcriptome profile of the biological tissue, the second transcriptome profile corresponding to the displacement image;
performing, based on the coarse transformation, coarse registration of the particular displaced spatial coordinates relative to the particular reference spatial coordinates, resulting in second particular displaced spatial coordinates of the spots within the second transcriptome profile; and
performing, based on the registration transformation, fine registration of the second particular displaced spatial coordinates of the spots within the second transcriptome profile.

27. The computer-implemented method of claim 25, wherein the training comprises determining a solution to an optimization problem with respect to a loss function based on a similarity metric of a first pair of training label maps of multiple pairs of training label maps and a deformation vector field associated with a first training reference image and a first training displaced image in a pair of the multiple pairs of training images, wherein the solution defines the trained machine-learning alignment model.
